(19) United States
(12) Patent Application Publication
(10) Pub. No.: US 2025/0186928 A1
(43) Pub. Date: Jun. 12, 2025

(54) EXPANDABLE PLEATED AIR FILTERS

(71) Applicant: 3M INNOVATIVE PROPERTIES COMPANY, St. Paul, MN (US)

(72) Inventors: Bryan L. Gerhardt, Woodbury, MN (US); Dennis M. Glass, Cottage Grove, MN (US); Benjamin B. Gulsvig, Woodbury, MN (US); Jacob T. Lusson, Richfield, MN (US); Michael L. Munson, Maple Grove, MN (US); Mark A. Sanocki, Vadnais Heights, MN (US); Andrew R. Fox, Oakdale, MN (US)

(21) Appl. No.: 18/952,714

(22) Filed: Nov. 19, 2024

Related U.S. Application Data
(60) Provisional application No. 63/607,882, filed on Dec. 8, 2023.
(60) Provisional application No. 63/684,639, filed on Aug. 19, 2024.

(51) Int. Cl. B01D 46/52; B01D 39/14; B01D 46/00; B01D 46/42

(52) U.S. Cl. CPC B01D 46/522; B01D 39/14; B01D 46/0001; B01D 46/0004; B01D 46/0005; B01D 46/0032; B01D 46/4227; B01D 46/4254; B01D 46/523; B01D 2239/0435; B01D 2239/0618; B01D 2239/0654; B01D 2239/0681; B01D 2239/10; B01D 2265/04; B01D 2265/06; B01D 2275/10; B01D 2279/50

(57) ABSTRACT

Expandable pleated air filters, reusable frames for such air filters, kits for making framed air filters, and methods of making and using framed air filters. The pleated air filter may have first and second non-corrugated ends that have first and second securing tabs that are configured to be inserted into first and second upward-open-ended elongate slots of a frame. The pleated air filter may have first and second corrugated edges at which first and second corrugated edges of a compliant nonwoven electret filter media of the pleated air filter extends outward beyond first and second corrugated edges of a stiffening layer of the pleated air filter, so that the first and second corrugated edges of the pleated air filter are self-sealing when abutted against inward sidewalls of a frame in which the pleated air filter is installed.

### CROSS REFERENCE TO RELATED APPLICATIONS

This application claims priority from U.S. Provisional Application Ser. No. 63/607,882, filed 8 Dec. 2023, and U.S. Provisional Application Ser. No. 63/684,639, filed 19 Aug. 2024, the disclosure of which is incorporated by reference in its/their entirety herein.

### BACKGROUND

Air filters are commonly used in powered air-handling apparatus, e.g. residential and commercial heating and air-conditioning (HVAC) systems, room air purifiers, and so on, in order to remove dust and dirt particles, fine particulates and so on. Conventional air filters have permanent rigid frames that dictate that the air filter must exhibit its in-use size when shipped to a retailer, when presented to potential purchasers, and when stored by an end-user. Consequently, these air filters undesirably occupy a relatively large volume of space on transportation vehicles, on retailer shelves, and in end-user's homes.

### SUMMARY

Disclosed herein are expandable pleated air filters, frames for such air filters, kits for making framed air filters, and methods of making and using framed air filters. In one aspect, such a pleated air filter may have first and second non-corrugated ends that have first and second securing tabs that are configured to be inserted into first and second upward-open-ended elongate slots in a frame. In another aspect, such a pleated air filter may have first and second corrugated edges at which first and second corrugated edges of a compliant nonwoven electret filter media of the pleated air filter extends outward beyond first and second corrugated edges of a stiffening layer of the pleated air filter, so that the first and second corrugated edges of the pleated air filter are self-sealing when abutted against inward sidewalls of a frame in which the pleated air filter is installed. These and other aspects will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a perspective view, from an upward side, of an exemplary pleated air filter installed in an exemplary reusable frame to form a framed air filter.

FIG. 2 is an exploded perspective view of an exemplary frame, viewed from the upward side.

FIG. 3 is an exploded perspective view of the frame of FIG. 2, viewed from the downward side.

FIG. 4 is a perspective view, generally from the upward side, of the frame of FIG. 2.

FIG. 5 is a perspective view of a corner portion of an exemplary frame base.

FIG. 6 is a perspective view of a corner portion of another exemplary frame base.

FIG. 7 is a cross-sectional view of an exemplary frame, viewed along a primary direction of the frame.

FIG. 8 is a cross-sectional view of an exemplary frame, viewed along a secondary direction of the frame.

FIG. 9 is a perspective view, from an upward side, of an exemplary pleated air filter.

FIG. 10 is a perspective view of an exemplary pleated air filter in a compacted configuration.

FIG. 11 is a plan view of a single pleat-panel of an exemplary pleated air filter.

FIG. 12 is a side view of an exemplary pleated air filter.

FIG. 13 is a plan view of an exemplary pleated air filter with a reinforcing sheet mounted on the end pleat-panel so that the end pleat-panel is a reinforced end pleat-panel that can serve as a securing tab.

FIG. 14 is a plan view of multiple reinforcing sheets before being separated for mounting onto an end pleat-panel.

FIG. 15 is a cross-sectional view of an exemplary framed air filter in a vertically upright orientation.

Like reference numbers in the various figures indicate like elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

As used herein as a modifier to a property, attribute or relationship, the term “generally”, unless otherwise specifically defined, means that the property, attribute or relationship would be readily recognizable by a person of ordinary skill but without requiring absolute precision or a perfect match (e.g., within +/−20% for quantifiable properties). The term “substantially” means to a high degree of approximation (e.g., within +/−10% for quantifiable properties) but again without requiring absolute precision or a perfect match. The term “configured to” and like terms is at least as restrictive as the term “adapted to”, and requires actual design intention to perform the specified function rather than mere capability of performing such a function. The term “integral” denotes items that are portions of the same overall entity, are of the same composition, and that were made concurrently in the same manufacturing process, e.g. by injection molding.

Terms such as “outer”, “outward”, “outwardmost”, “outwardly”, and the like, refer to a direction generally away from the geometric center of an air filter, a frame for an air filter, and a and framed air filter. Terms such as “inner”, “inward”, “inwardmost”, “inwardly”, and the like, refer to a direction generally toward the geometric center.

The term “upward” and like terminology are defined as the direction that the open ends of open-ended elongate slots of a frame generally face, as discussed in detail later herein. The term “downward” and similar terms denote an opposing direction. Various Figures are marked with “U” and “D” to aid in recognition of upward and downward directions. This terminology is used in view of the fact that in many embodiments, a frame base that is to receive an air filter will be placed on a horizontal surface (e.g. a tabletop or countertop) with the open ends of the elongate slots facing up as discussed later herein. This terminology is used for ease of description and does not limit the orientation that a framed air filter can be placed in, e.g. when it is installed into a receptacle of a powered air-handling apparatus.

The term “upstream” is used to denote a side of a framed air filter (and a frame and air filter thereof) upon which, with the framed air filter installed in a powered air-handling apparatus, moving air will impinge on the framed air filter to be filtered thereby. The term “downstream” is used to denote the side of such items from which filtered air will exit. In many embodiments (e.g. in a “standard” installation as discussed later herein) the upward side of a framed air filter may correspond to the upstream side of the framed air filter as installed in a powered air-handling apparatus, with the downward side of the framed air filter similarly corresponding to the downstream side as installed in the powered air-handling apparatus. However, in some embodiments (e.g. in a “reverse” installation as discussed later herein) this may not be the case.

### DETAILED DESCRIPTION

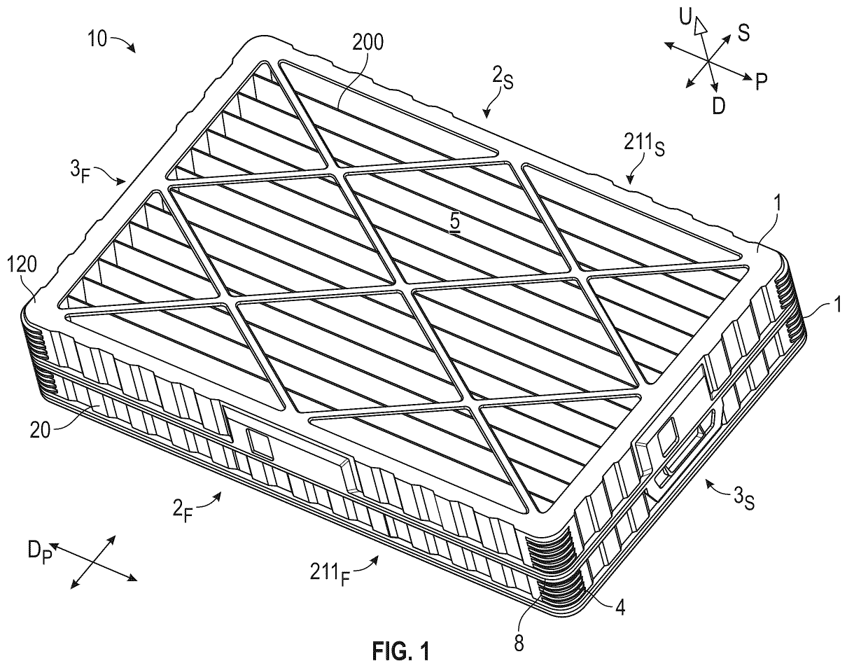

Shown in FIG. 1 in perspective view generally from the upward side is an exemplary framed air filter 10 as disclosed herein. Framed air filter 10 comprises a pleated air filter 200 installed in a reusable frame 1. In many embodiments, pleated air filter 200, frame 1, and framed air filter 10, will all be at least generally rectangular in shape (which specifically includes square shapes). Frame 1 may thus take a rectangular form with four major elongate frame portions in two opposing pairs. For reasons that will become clear below, one pair of opposing frame portions will be termed primary portions 2 and another pair of opposing portions will be termed secondary portions 3, with the primary and secondary portions meeting at frame corners 4. In some Figures herein, first and second opposing primary portions are labeled 2_{F} and 2_{S}; first and second opposing secondary portions are labeled 3_{F} and 3_{S}. Other items and components (of both frame 1 and pleated air filter 200) that are present in pairs (or, in general, in multiples) may be similarly labeled and/or referred to herein. Here and elsewhere, the terminology of first and second is for convenience of description and does not imply any classification as to function or order, unless specifically noted.

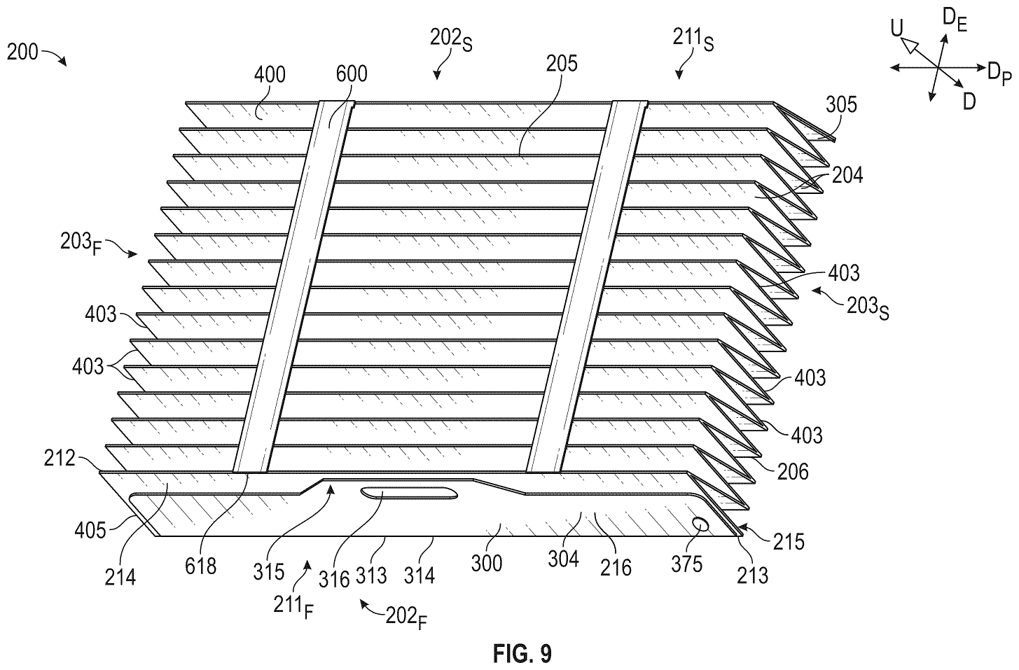

Frame 1 is reusable and is configured to define an air-filter receptacle 5 that accepts a pleated air filter 200 therein. As depicted in FIG. 9, pleated air filter 200 comprises first and second opposing primary ends 202_{F} and 202_{S} that are non-corrugated ends and that respectively comprise first and second securing tabs 216 in the form of reinforced end pleat-panels 211_{F} and 211_{S}; and, first and second opposing secondary edges 203_{F} and 203_{S} that are corrugated edges, as described in detail later herein. The securing tabs 216 of pleated air filter 200 are insertable into upward-open-ended elongate slots 25 (visible in various Figures herein) of frame 1 in order to install air filter 200 into frame 1. Thus, the primary portions 2 of frame 1 are those that comprise upward-open-ended elongate slots 25 and to which the primary ends 202 of air filter 200 are attached; the secondary portions 3 of frame 1 are those along which the secondary, corrugated edges 203 of the air filter are positioned, all as described in detail herein. Frame 1 will have a primary direction and axis that is parallel to primary portions 2 of frame 1; and, a secondary direction and axis that is parallel to secondary portions 3 of frame 1; primary direction/axis P and secondary direction/axis S are denoted in various Figures.

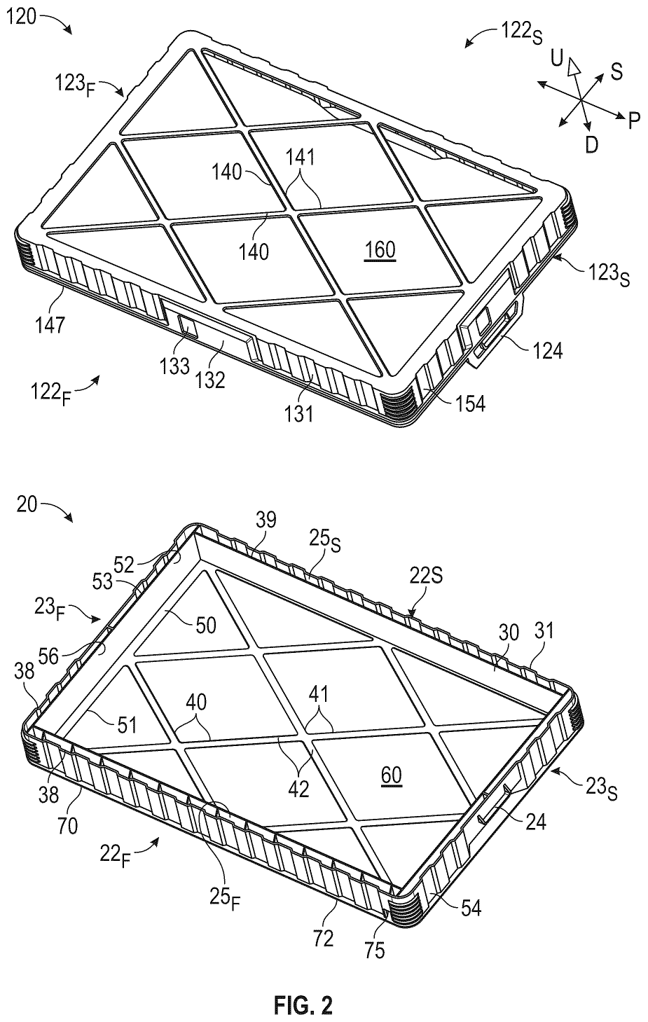

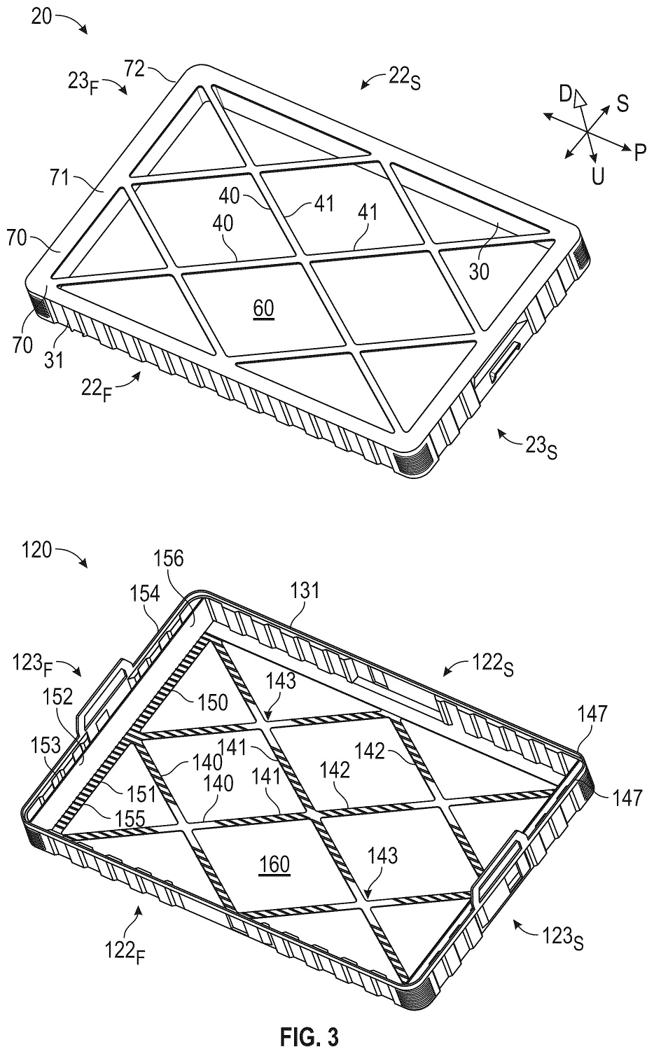

As evident e.g. from FIGS. 2 and 3, frame 1 is comprised of two major frame pieces 20 and 120 that are assembled together with air filter 200 therein to form framed air filter 10. Frame piece 20 will be referred to herein as a frame base; frame piece 120 will be referred to herein as a frame cover. Frame 1, as made by joining frame base 20 and frame cover 120, will define a filter receptacle 5 that is configured to receive pleated air filter 200. In some embodiments, frame base 20 and frame cover 120 may be similar or nearly equal in size, depth, and so on (as in the exemplary design of FIGS. 1-4), e.g. so that the upward-downward depth of the frame cover is within 30, 20, 10, or 5% of the upward-downward depth of the frame base. In other embodiments, frame base 20 may constitute the major portion of frame 1 (in particular, frame base 20 may comprise sidewalls that define the majority of the depth of the air-filter receptacle 5 of the thus-formed frame). In such embodiments frame cover 120 may consist mainly of a cover that closes an opening of frame base 20, with frame cover 120 providing only a small portion (or no portion) of the sidewalls that define the air-filter receptacle 5. In some embodiments, frame cover 120 may comprise latch members 124 that are configured to be secured to latch catches 24 of frame base 20. In some embodiments, latch members 124 may be integral with frame cover 120 (rather than being e.g. attached to frame cover 120 by hinges) and may be outwardly deflectable so that they can be passed outward of latch catches 24 and can then return to their undeflected condition to hold frame base 20 and frame cover 120 together.

In some embodiments, frame base 20 will comprise a downward lattice 40 collectively provided by downward struts 41; typically, such struts will be integral with the primary and secondary portions of the frame base. In some such embodiments, such a lattice, being downstream of pleated air filter 200 (when framed air filter 10 is inserted into a receptacle of a powered air-handling apparatus in a standard configuration as discussed later herein), may primarily serve to support the pleated air filter against the pressure developed by the moving air impinging on air filter 200. (In other words, downward support lattice 40 may primarily serve to prevent pleated air filter 200 from billowing or otherwise deforming in the downstream direction due to the air pressure).

In some embodiments, frame cover 120 will comprise an upward lattice 140 collectively provided by upward struts 141; typically, such struts will be integral with the frame cover. Although it may be similar in appearance to downward support lattice 40, in some embodiments (e.g., when framed air filter 10 is used in a standard configuration) upward lattice 140 may not necessarily serve to support pleated air filter against air pressure in the manner of downward support lattice 40. Rather, in at least some embodiments upward lattice 140 can be configured (as discussed in detail later herein) to serve an anti-sag function; e.g. to keep the pleats of air filter 200 from sagging due to their own weight.

In many embodiments, frame base 20 and frame cover 120 may be made by injection molding of any suitable organic polymeric thermoplastic material, e.g. acrylonitrile-butadiene-styrene (ABS), nylon, polypropylene, and so on. In many embodiments, frame 1 may be a two-piece design with frame base 20 and frame cover 120 being completely separable from each other as evident in FIGS. 2 and 3. In other embodiments, frame 1 may comprise a clamshell design in which frame base 20 and frame cover 120 are hingedly attached to each other.

As disclosed herein, a pleated air filter 200 can be installed into the above-described reusable frame 1. An exemplary pleated air filter 200 is shown, from the upward side, in FIG. 9. By “pleated” is meant a sheet-like entity that has been folded into rows of generally parallel, oppositely oriented folds that provide alternating peaks and valleys on both sides of the entity. As shown in FIG. 9, pleated air filter 200 includes a plurality of pleat-panels 204 and comprises an upward side 250 with upward pleat tips 205, and a downward side 270 with downward pleat tips 206. Such a pleated air filter will exhibit a pleat direction (D_{P}, indicated in FIG. 9) that is parallel to the long axes of the pleat tips.

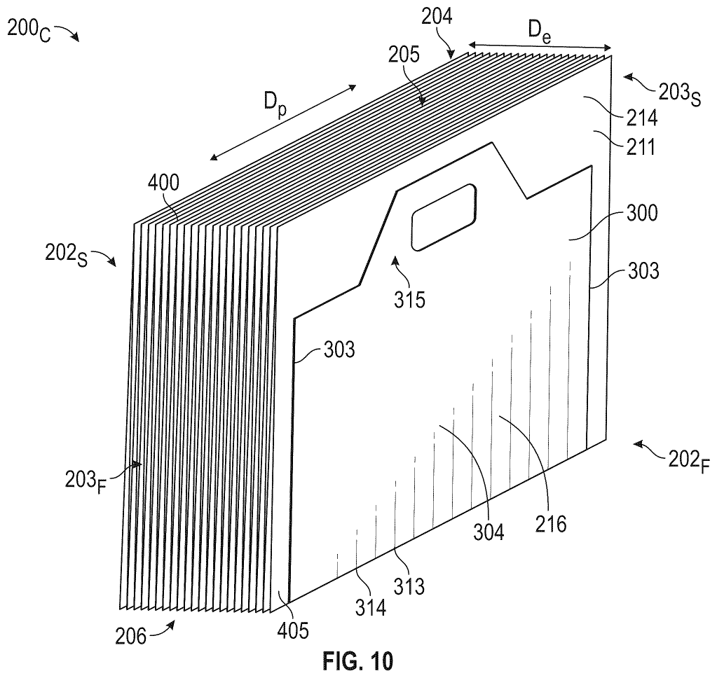

Pleated air filter 200 as disclosed herein can be provided to an end-user in a compacted configuration (equivalently, a collapsed condition), in which the pleat tips (and pleat-panels) are crowded quite close together or even in contact with each other. Such a compacted pleated air filter may be referred to as a “pleatpack” and is depicted in exemplary embodiment in FIG. 10 (with the pleated air filter being labeled 200c for compacted). Such a pleatpack can be expanded into its in-use configuration (depicted in FIG. 9) for installation into reusable frame 1. Pleated air filter 200 will thus have an expansion direction D_{E} (indicated in FIGS. 9 and 10) that is perpendicular to the pleat direction D_{P} and along which the pleated air filter can be expanded from a compacted configuration to an expanded, in-use configuration. When air filter 200 is installed into frame 1, the expansion direction D_{E} of air filter 200 will be parallel to the above-described secondary direction S of frame 1, and the pleat direction D_{P} of air filter 200 will be parallel to the above-described primary direction P of frame 1.

In many embodiments, pleated air filter 200 may be provided (e.g. in a kit) in a compacted configuration, and expanded into the in-use configuration (e.g., a condition in which the pleated filter has a length that matches the length of the filter receptacle of frame 1) by an end-user. The pleated air filter is configured to quickly and easily transition from a collapsed configuration to an expanded, in-use configuration. In some embodiments, a removable wrapper or other packaging can be provided to initially retain the air filter in the collapsed state, and can be removed to allow expansion. The air filter does not require a conventional, factory-installed rigid frame permanently surrounding the pleated air filter, and can advantageously be packaged, stored, shipped, inventoried, and so on, in the collapsed state.

A pleated filter 200 can thus be expanded at least once from a collapsed condition to an expanded, in-use condition, along an expansion direction D_{E}; in many embodiments, the pleated air filter can only expand along this single direction. In some embodiments, the pleated air filter can be repeatedly transitioned back and forth between an expanded, in-use condition and a collapsed condition. However, in some embodiments the air filter may only need to be expandable from a collapsed condition to an expanded, in-use condition a single time. That is, in some such embodiments, the pleated air filter may not need to be collapsible back to the original collapsed condition.

Pleated air filter 200 will comprise first and second opposing ends 202_{F} and 202_{S}, which are termed “primary” ends as noted earlier. Each primary end will comprise a securing tab 216 that is configured to be insertable into an upward-open-ended elongate slot 25 of frame base 20 to secure pleated air filter 200 to frame base 20. In some embodiments, such a securing tab 216 will be provided by an end pleat-panel 211 that is reinforced to exhibit increased stiffness, mechanical robustness, etc. (so that it can serve as a securing tab) as discussed in detail later herein. Thus in some embodiments, a securing tab 216 at first opposing end 202_{F} and/or a securing tab 216 at second opposing end 202_{S} will take the form of a reinforced end pleat-panel, as depicted in exemplary embodiment e.g. in FIGS. 9 and 10. First and second reinforced end pleat-panels 211 of pleated air filter 200 are configured to be inserted into the above-mentioned upward-open-ended elongate slots 25 of the first and second primary frame portions 2 of reusable frame 1. Specifically, slots 25 will be provided in the frame base 20; once air filter 200 is installed into slots 25 of frame base 20, frame cover 120 can then be mated to frame base 20 and attached thereto, to form the completed, ready-for-use framed air filter 10.

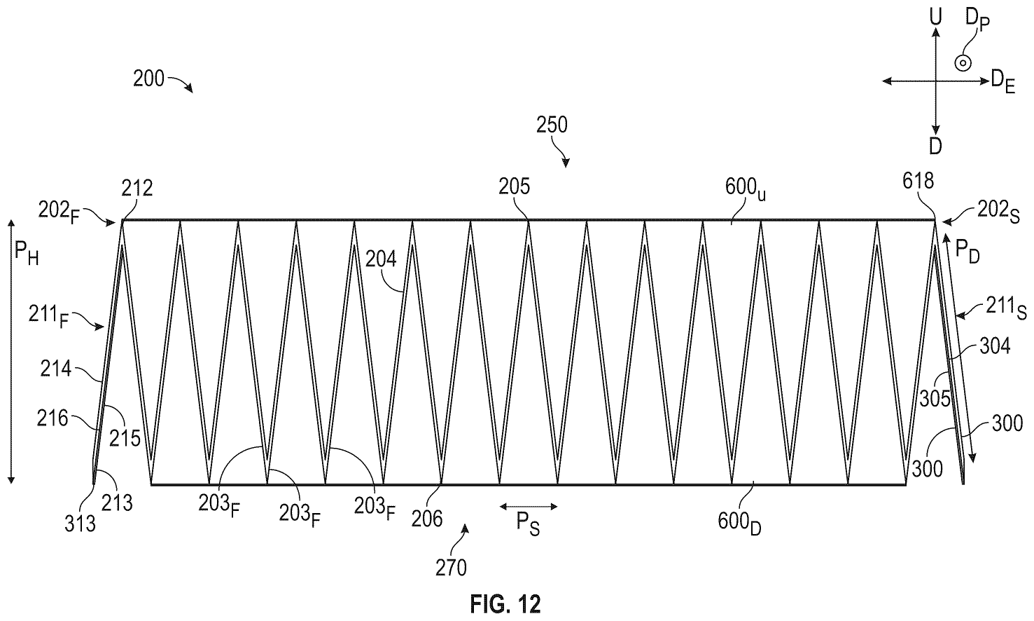

A pleated air filter 200 will also comprise first and second opposing edges 203_{F} and 203_{S}, which will be termed “secondary” opposing edges. By definition, these secondary edges of air filter 200 are “corrugated edges”; the above-described primary opposing ends 202 are not corrugated. (A “corrugated” edge of a pleated air filter is one that exhibits an overall, generally zig-zag shape when viewed along the pleat direction D_{P}, as is evident from FIGS. 9 and 12; the term corrugated does not imply that the edges of individual pleat-panels are nonlinear.) In a framed air filter 10 as disclosed herein, the first and second secondary, corrugated opposing edges 203 of air filter 200 will be closely abutted against (i.e., in contact with) inward surfaces 16 of inward sidewalls 12 of secondary frame portions 2 of frame 1.

Pleated air filter 200 comprises a layer of filter media 400, of any suitable type and composition. Such media (and the resulting air filter) is typically sheet-like, with a length along the expansion direction D_{E}, and a width along the pleat direction D_{P}, that are considerably greater than the local thickness of the air filter and its filter media. Herein, the term “width” is used for the dimension of air filter 200 and filter media 400 along their pleat direction and for the dimension of frame 1 along its primary direction; the term “length” is used for the dimension of air filter 200 along its expansion direction and for the dimension of frame 1 along its secondary direction. These terms are used purely for convenience of description. The length of air filter 200 and/or frame 1 need not necessarily be greater than its width; in fact, in the exemplary designs shown e.g. in Figures herein, the width of these items is indeed greater than their length.

In some embodiments, filter media may be, or include, a nonwoven material such as e.g. a meltspun/spunbonded nonwoven web or a meltblown nonwoven web. In some embodiments, filter media may comprise fiberglass fibers. In some embodiments, the filter media may be configured to perform air filtration so as to remove particulates from a stream of moving air. Nonwoven webs which may be used as, or as a layer, of, air filter media can be a high loft spunbond web, such as described, for example, in U.S. Pat. No. 8,162,153. In some embodiments, the filter media can be, or include, a low loft spunbond web, such as those described in U.S. Pat. No. 7,947,142. In some embodiments, an electrostatic charge is optionally imparted into or on to material(s) of the filter media. Thus, the filter media can be an electret nonwoven web. Electric charge can be imparted to the filter media in a variety of ways as is well known in the art, for example by hydrocharging, corona charging, etc. (e.g. as described in U.S. Pat. No. 7,947,142). In other embodiments, the filter media is not electrostatically charged. Pleats can be formed in the filter media using various methods and components as are well known in the art, for example those described in U.S. Pat. Nos. 6,740,137 and 7,622,063. In some embodiments, the filter media may be a diamond-pleated media of the general type as described e.g. in U.S. Provisional Patent Application 63/530,463, entitled DIAMOND-PLEATED FILTER MEDIA, and as described in any subsequent US or PCT patent application derived therefrom, all of which are incorporated by reference in their entirety herein.

In some embodiments, the filter media 400 will be compliant, by which is meant that the filter media exhibits a Gurley stiffness that is less than 2000 (units of Gurley stiffness are milligrams). Gurley stiffness can be measured according to the apparatus and procedures described in U.S. Patent Application Publication No. 2022/0266180, which is incorporated by reference herein for this purpose. In various embodiments, the filter media 400 may exhibit a Gurley stiffness of less than 1500, 1000, 600, 400, or 200 mg. In some embodiments, the filter media may exhibit a Gurley stiffness of at least 25, 50, 75, 100, 125, or 150 mg.

The present investigations have revealed that even when a pleated air filter 200 comprises filter media 400 along with a stiffening layer 500 as discussed below, in some instances local areas of pleat-panels in close proximity to a pleat tip that is upstream (as installed in a receptacle of a powered air-handling apparatus) may slightly, locally deform under the pressure of incoming air. In some circumstances this slight deformation can locally “pinch” these areas of the pleat-panels toward each other in a manner that slightly lowers the overall surface area of pleated material available for filtration, and can thus cause a small, but observable, drop in the filtration performance. Such phenomena, if of importance in any particular instance, may be mitigated e.g. by providing that at least the pleat tips that are upstream as installed, are not extremely “sharp”. Thus for example, in various embodiments a pleated air filter may comprise at least upstream pleat tips that exhibit an average radius of curvature of from 1 to 4 mm. (Such parameters will be measured on the inside of the tips, with the pleated air filter in its expanded, in-use condition.) Such conditions may not necessarily be needed for pleat tips that are downstream as installed; however, in most instances, the pleating process will be carried out such that the upstream and downstream pleat tips exhibit the same average radius of curvature.

In some embodiments, air filter 200 may comprise a stiffening layer 500. Such a stiffening layer is, by definition, a layer of material that is permanently attached (e.g. laminated) to the above-described layer of filter media 400. The stiffening layer may be attached directly to the layer of filter media, or some intermediate layer or layers may be present. The purpose of the stiffening layer is to increase the overall stiffness of the air filter so that the air filter can be pleated, and to ensure that the pleated structure, once formed, is stable. In other words, a stiffening layer can help ensure that the air filter, after being pleated, does not tend to immediately relax back to a generally planar (unpleated) configuration. By definition, a stiffening layer 500 is co-pleated with the filter media 400, meaning that the stiffening layer is attached to the layer of filter media, after which both layers are pleated in the same pleating operation. A stiffening layer will thus be attached generally to all of the pleat-panels of the pleated structure rather than just being attached to pleat tips of the pleated structure. In various embodiments, a stiffening layer 500 may be provided on an upstream side of filter media 400 (as installed in a powered air-handling apparatus), on a downstream side of filter media 400, or on both sides. In some embodiments, a stiffening layer 500 will be present on the downstream side of filter media 400 but not on the upstream side.

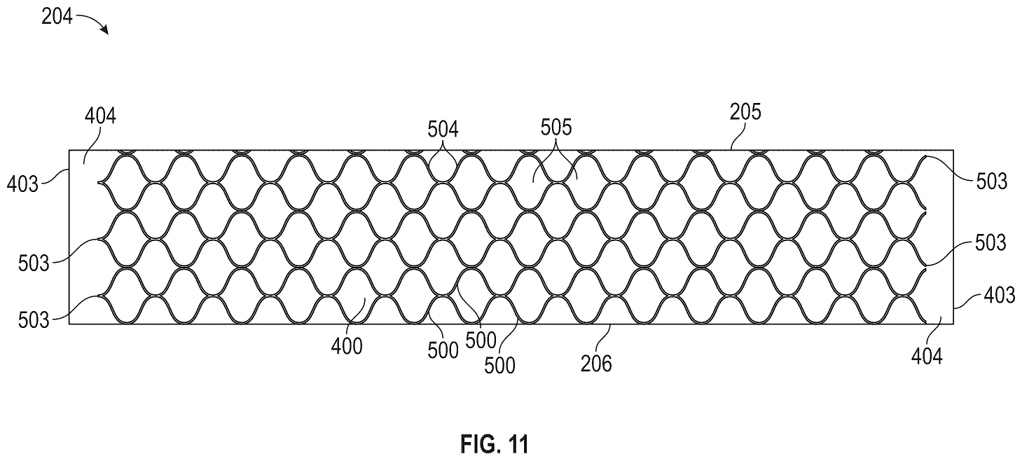

A view of a single pleat-panel 204 that comprises a layer of filter media 400 and a stiffening layer 500 bonded thereto is presented in FIG. 11. (A stiffening layer 500 is not included in any other Figure, so that other items and details can be more easily seen.) In the depicted embodiment of FIG. 11, stiffening layer 500 is in the form of a layer of mesh, netting, or the like, that is collectively provided by filaments 504 that define through-openings 505, and that exhibits a very high (e.g., greater than 90, 95, or 98%) open area so as to be highly air-transmissive. In some embodiments, such a mesh may be comprised of metal filaments and may be e.g. adhesively bonded to the surface of filter media 400. Such bonding may be achieved e.g. by lamination of the wire mesh to the filter media while both items are not yet pleated (and are e.g. in a roll or jumbo format), with the bonded layers then being co-pleated thereafter.

A thus-formed pleated filter 200 will exhibit a pleat height P_{H}, a pleat spacing P_{S}, and a pleat distance P_{D}, all as indicated in FIG. 12. These are well-known parameters for characterizing a pleated structure; the pleat distance is non-changeably established in the pleating operation but the pleat height and the pleat spacing may vary depending on the degree to which the pleated filter is expanded or compacted. Filter media 400 and stiffening layer 500 will both exhibit a width in a direction that is parallel to the above-described pleat direction after the pleating is performed. In some embodiments, stiffening layer 500 may be configured so that the width of stiffening layer 500 is less than the width of filter media 400. In other words, in some embodiments the secondary edges 503 of stiffening layer 500 will stop short of the secondary edges 403 of filter media 400, as evident from FIG. 11. The opposing secondary ends of filter media 400 will thus comprise a small amount of “extra” material 404 that extends (along the pleat direction of the air filter and along the primary direction of the frame) beyond the secondary edges 503 of the stiffening layer. The secondary edges 403 of filter media 400 will thus provide the previously-described secondary, corrugated edges 203 of air filter 200.

The secondary-edge portions 404 of filter media 400, being locally unstiffened by stiffening layer 500, can serve a useful purpose. To this end, filter media 400 can be chosen to be compliant as defined and described above. When air filter 200 is installed in frame 1 so that secondary edges 403 of filter media 400 are abutted against the inward surfaces 16 of inward secondary sidewalls 12 of frame 1, the secondary edges 403 of filter media 400 are able to locally conform to surfaces 16. That is, portions 404 of filter media being compliant and being locally unstiffened by stiffening layer 500, portions 404 are, on a local scale, flexible and resiliently conformable rather than being stiff and rigid. At least the edges 403 of portions 404 are thus able to locally bend, conform, and so on, when abutted against surface 16 of frame 1. This can provide that the secondary edges 403 of filter media 400, and thus the secondary edges 203 of air filter 200 as a whole, can “self-seal” against the inward surfaces 16 of inward secondary sidewalls 12 of frame 1. This can minimize any air leaks around secondary edges 203 of air filter 200, without any need for the secondary edges of air filter 200 to be adhesively bonded to the inward secondary sidewalls 12 of frame 1 (in general, without the need for any portion of air filter 200 to be adhesively bonded to frame 1); and, without the need for any added item or material to serve as a gasket, seal, caulk, space-filler, etc. Thus in some embodiments, neither air filter 200 nor frame 1 will comprise any item (such as e.g. a strip of resilient foam or the like) that serves to provide a gasketing, sealing, and/or space-filling function, other than the secondary-edge portions 404 of filter media 400.

Thus in various embodiments, the secondary edges 403 of filter media 400 may extend outward beyond the secondary edges 503 of the stiffening layer a distance of at least 2, 3, 4, 6, or 8 mm. In further embodiments, secondary edges 403 of filter media 400 may extend outward beyond secondary edges 503 of stiffening layer 500, a distance of no more than 30, 25, 20, 15 or 10 mm.

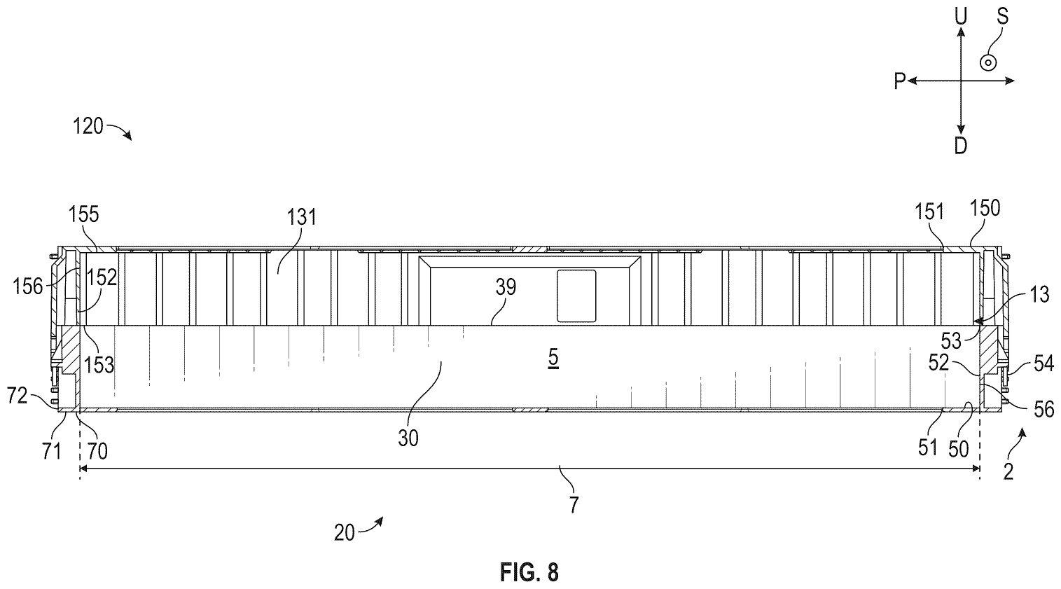

In some embodiments, the above-referenced width of filter media 400 may be chosen to be slightly greater than the width 7 of filter receptacle 5 (shown in FIG. 8), to ensure that the secondary-edge portions 404 of filter media 400 can perform the above-discussed self-sealing function. Thus in various embodiments, the width of filter-receptacle 5 of frame 1 along the primary direction of the frame may be from 1 to 7 mm less than the pleat-direction width of filter media 400.

In many embodiments, each primary terminal end of stiffening layer 500 will not be stopped short of a corresponding primary end of filter media 400 (although this can be done if desired), there typically being no need to provide a self-sealing functionality at the first and second primary ends 202 of air filter 200. That is, a primary terminal end of stiffening layer 500 may extend to a downward tip 213 of an end pleat-panel 211 of the air filter, rather than being e.g. cut short in relation to the end pleat-panel. However, as discussed later herein, in some embodiments a reinforcing sheet can be wrapped around the downward tip 213 of each end pleat-panel 211 of the air filter (and thus around the primary terminal end of the stiffening layer) so that an end-user does not come into contact with the primary terminal end of the stiffening layer when grasping and manipulating the air filter. This may be particularly advantageous e.g. if the stiffening layer is in the form of a wire mesh or netting of metal filaments.

In some embodiments, pleated air filter 200 may include one or more elongate members 600 that are configured to limit the expansion of each of the pleats of the pleated air filter to a predetermined length so that the pleated air filter exhibits a desired in-use configuration with a predetermined pleat spacing. That is, any such member 600 does not serve only to set the maximum overall length of the pleated filter in its in-use condition; rather, member(s) 600 will set the maximum in-use pleat spacings of all of the pleats of the filter. Any number of such pleat-spacing-limiting elongate members, e.g. one, two, three, or more, may be present. Such members may be on the upward or downward side of the pleated air filter, or on both. They may extend at least generally along the expansion direction of the pleated air filter and may be spaced apart along the pleat direction of the pleated air filter, and may be bonded to upward or downward pleat tips of the pleated air filter.

In the exemplary illustrations of FIG. 9, members 600 are in the form of elongate ribbons, straps, bands, or the like, that are bonded to pleat tips of the pleated air filter (e.g., bonded directly to air filter media 400, and/or to a stiffening layer 500 (or any other layer) present thereon). Even if in the form of relatively wide entities (e.g. ribbons or straps) of the general type depicted in FIG. 9, such members typically will not have a major affect on airflow or filtration performance. However, if desired, such a ribbon or strap may be chosen to be air-transmissive, e.g. in the form of a nonwoven scrim or netting. Thus in various embodiments, any such member or members may take the form of a nonwoven scrim, a netting, a wire mesh, a set of filaments, and so on. Such members, individually and collectively, will be distinguished from the above-described stiffening layer 500, by virtue of the pleat-spacing-limiting members 600 being bonded only to the pleat tips of the pleated air filter rather than being co-pleated with the pleated air filter. In some embodiments, such members may take the form of a set of extruded filaments of the general type described in U.S. Patent Application Publications 2021/0229022 and 2021/0229023, both of which are incorporated by reference in their entirety herein.

In some embodiments, any such members will be flexible (e.g. so that the members can fold or gather to accommodate their excess length when the pleated air filter is collapsed); in some such embodiments, any such entities may be inelastic so as to limit the pleat expansion to a desired amount that establishes a desired in-use pleat spacing. For example, such a member may take the form of one or more ribbons, strips, filaments, etc. that is attached to the pleat tips and that, when extended to its maximal length, provides a “dead-stop” at a desired span. Thus in some embodiments such an entity may be inelastic, meaning that it exhibits an elongation at break of less than 5%. In other embodiments, any such entity may be elastic, e.g. so as to exhibit an elongation at break of at least 5, 20, 50, 100, or 200%. Any such members may be bonded to the pleat tips of the pleated air filter in any suitable way. For example, a pressure-sensitive adhesive may be disposed on the surface of the members at least at locations where the members will contact the pleat tips. Or, the members may be ultrasonically bonded to the pleat tips, or may be melt-bonded thereto (e.g. by being extruded and extrusion-bonded to the pleat tips).

If present on the upward side of pleated air filter 200, any such member 600 may extend to, and be bonded to, an upward pleat tip 212 of an end pleat-panel 211, as with the exemplary upward member 600u shown in the side view of pleated air filter 200 in FIG. 12 (members 600 are not shown in various other Figures so that other items therein may be more easily seen). However, if any such member is present on the downward side of pleated air filter 200, in some embodiments the member may not extend to, nor be bonded to, the downward tip 213 of a reinforced end pleat-panel 211 that serves as a securing tab 216, as is the case with the exemplary downward member 600D of FIG. 12. This stopping any downward pleat-spacing-limiting elongate members 600 short of an end pleat-panel 211 can ensure that the presence of any downward member(s) 600 does not interfere with the ability to insert the end pleat-panel 211 into an elongate slot of a frame to install the air filter in the frame. (However, in embodiments discussed later herein, in which a securing tab 216 is provided by a piece of sheet-like reinforcing material that e.g. extends beyond the end pleat-panel 211, rather than by the end pleat-panel itself, it may be possible for an elongate member(s) to extend to, and to be bonded to, the end pleat-panel.)

As noted, pleated air filter 200 will comprise first and second securing tabs 216 at the first and second opposing primary ends 202 of filter 200. First and second securing tabs 216 are respectively insertable into first and second upward-open-ended elongate slots 25 of frame base 20 to secure air filter 200 to frame base 20. As mentioned, in some embodiments securing tabs 216 may be provided by end pleat-panels 211 of pleated filter 200, at first and second opposing primary ends 202 of pleated air filter 200. Any such end pleat-panel 211 that serves as a securing tab 216 may be a reinforced pleat-panel, by which is meant that the end pleat-panel, while comprising the same filter media as the other pleat-panels, has one or more entities mounted thereon, and/or is subjected to a suitable treatment, to significantly increase the stiffness of the end pleat-panel in comparison to the other pleat-panels of the pleated filter. (A stiffening layer 500 thus serves to increase the stiffness of all the pleat-panels, including the end pleat-panels, for the reasons discussed earlier herein, while an end pleat-panel can be reinforced to increase its stiffness still further, e.g. so that it exhibits a stiffness that is at least 2, 4, or 8 times or more, greater than the stiffness of the other pleat-panels.) A reinforced end pleat-panel can thus be configured to have appropriate physical properties to be seated into an elongate slot, to be securely held therein by ribs 33 and 36, and so on, in the general manner discussed later herein.

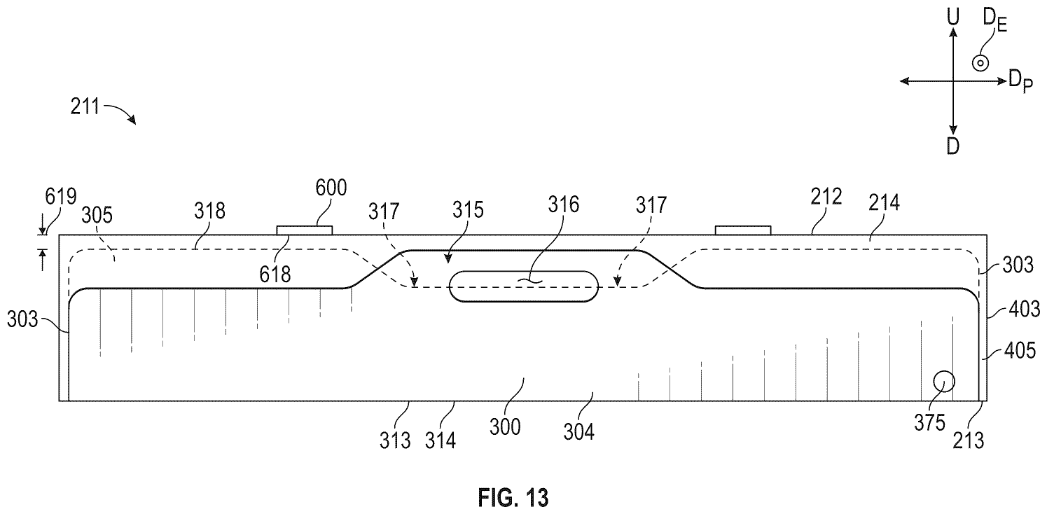

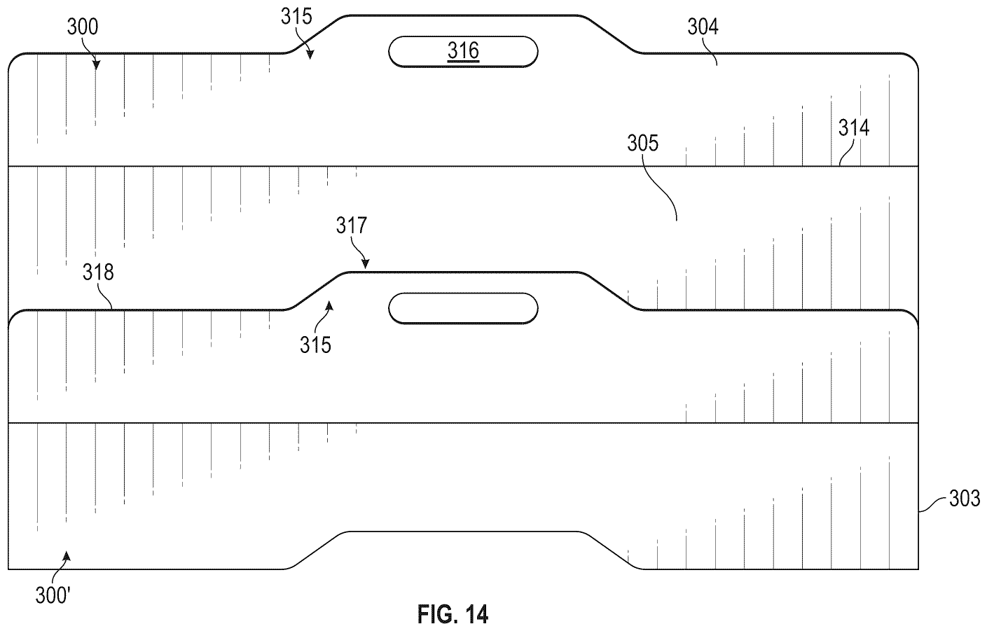

In some embodiments, a reinforced end pleat-panel 211 that can serve as a securing tab 216 may be obtained by taking a separately-made item such as a sheet-like reinforcing material 300 (e.g. a piece of suitably sized and shaped chipboard of appropriate thickness) and mounting it on an inward face 215 and/or an outward face 214 of end pleat-panel 211. In some embodiments, such a reinforcing sheet 300 may comprise an outward segment 304 that is attached to an outward face of the end pleat-panel and an inward segment 305 that is attached to an inward face of the end pleat-panel. Such arrangements are depicted in exemplary embodiment in FIG. 9, in which the entirety of an outward segment 304 is visible on the outward face 214 of a first end pleat-panel 211r, and in which a small area of an inward segment 305 is visible on the inward face of a second end pleat-panel 211s. In some convenient embodiments, the inward and outward segments can be segments of a single piece of chipboard (for example, a piece 300 or a piece 300′, as depicted in FIG. 14), that comprises a fold line (made by scoring, perforating, etc.) 314. The single piece of chipboard can be folded along fold line 314 and can thus be “wrapped around” the downward tip 213 of an end pleat-panel 211 such that a downward apex 313 of the chipboard becomes located downward of the downward tip 213 of the end pleat-panel. Such arrangements are illustrated in further detail in FIG. 13, which presents an isolated view of a single end pleat-panel 211, with a single piece of chipboard 300 having been wrapped around the downward tip 213 of the end pleat-panel and attached to the inward and outward faces of the end pleat-panel. The inward segment 305 of chipboard 300 is behind the end pleat-panel 211 in this view, and is depicted in dotted lines.

Any such reinforcing sheet 300 may be bonded to the inward and/or outward face of an end pleat-panel in any suitable way, e.g. by adhesive bonding, by the use of mechanical fasters such as e.g. staples, and so on. In some embodiments, various other methods to reinforce an end pleat-panel may be used, whether alone or in addition to the arrangements described above. For example, an end pleat-panel of the air filter may be impregnated with a liquid resin that, after hardening, will render the end pleat-panel stiff and rigid. Another possibility is to gather several panels at the end of the pleated air filter, press them together, and attach them to each other (in any suitable way) to collectively form, in effect, a single, thickened and stiffened end pleat-panel that can serve as a securing tab. In another variation, a reinforcing sheet 300 can be attached to (e.g. wrapped around) several such gathered pleat-panels rather than being attached to (e.g. wrapped around) a single end pleat-panel.

However made, a securing tab 216 (e.g. a reinforced end pleat-panel 211) will typically be elongate with a long axis that is aligned with the pleat direction D_{P} of the air filter, as is evident e.g. from FIGS. 9 and 13. Such a securing tab 216 will have a downward, leading end (e.g. comprising the downward tip 213 of pleat-panel 211) that can be inserted into an upward-open-ended elongate slot of a frame 1, and will have an upward, trailing end (e.g. comprising upward pleat tip 212) at which the end pleat-panel integrally meets a penultimate pleat-panel, as evident from FIG. 12.

Additional arrangements are possible. For example, FIGS. 9-10 and 13-14 depict an arrangement in which the outward segment 304 of reinforcing sheet 300 comprises an upward extension 315 in a central area of the outward segment (in this instance “central” is with respect to the pleat direction D_{P}). In some embodiments, upward extension 315 may remain unattached to the area of the end pleat-panel that extension 315 closely abuts (for example, an adhesive that is used to bond the other areas of outward segment 304 to the outward face 214 of end pleat-panel 211 may be omitted in this area). So, if desired, an end-user may manually move extension 315 (e.g. with their fingers) slightly away from the outward face 214 of end pleat-panel 211 so that extension 315 can serve as a handle. In some embodiments, handle 315 may be provided with a through-aperture 316 to further facilitate it being grasped. It is noted that (e.g. even if upward extension 315 is bonded to the end pleat-panel so that extension 315 cannot be easily used as a grasping handle by itself) in some embodiments an end-user may be able to push both of the primary ends of pleated air filter 200 toward each other to collapse air filter 200 into its compact configuration as shown in FIG. 10. With the air filter in its collapsed configuration, the end-user can e.g. put their fingers on one extension 315 (or any portion of reinforcing sheet 300) at one primary end of the air filter and their thumb on extension 315 (or, again, any portion of sheet 300) at the other primary end of the air filter, and grasp the entire compacted air filter in that manner. As mentioned earlier, providing reinforcing sheets 300 that are wrapped around the downward tips 213 of the end pleat-panels 211 of the air filter in the general manner described herein, can ensure that each reinforcing sheet 300 also wraps around, and covers, a previously-described terminal end of a stiffening layer 500, at or near the downward tips 213 of the end pleat-panels. This can ensure that an end-user does not come into contact with a terminal end of the stiffening layer when grasping and manipulating the air filter.

In some embodiments, a number of reinforcing sheets 300 may be obtained by cutting (e.g. die cutting, laser cutting or the like) appropriately shaped pieces from a single sheet of chipboard (i.e., from a chipboard “blank”). To minimize the amount material that remains unused in manufacturing the reinforcing sheets 300, the shapes of the reinforcing sheets 300 may be chosen so that a handle 315 in an as-cut reinforcing sheet (e.g. sheet 300′ as shown in FIG. 14), corresponds to a notch 317 in the adjacent as-cut reinforcing sheet (e.g. sheet 300 of FIG. 14). As shown in FIG. 13, such arrangements will cause the upward portion of an inward segment 305 of the resulting reinforcing sheet 300 to have an upward notch 317. Upward notch 317 of inward segment 305 will be congruent with upward extension 315 of outward segment 304, meaning that notch 317 and extension 315 share identical (mirror-image) shapes and sizes as evident in FIG. 13 (ignoring the presence of any aperture 316 in extension 315).

Another advantageous arrangement can be pointed out in reference to FIG. 13. As noted earlier herein, in some embodiments, pleated air filter 200 may include one or more elongate members 600 that are configured to limit the expansion of the pleated air filter to a desired in-use configuration in which the pleated air filter exhibits a predetermined pleat spacing. In some embodiments, such a member 600 may be bonded to upward pleat tips of the pleated air filter, including an upward pleat tip 212 of the end pleat-panel 211 on which a reinforcing sheet 300 is mounted. It has been found that extending an inward segment 305 of a reinforcing sheet along the inward face 215 of end pleat-panel 211 in a generally upward direction so that an upward edge 318 of inward segment 305 is positioned relatively close to a location 618 at which a pleat-spacing-limiting elongate member 600 is bonded to the upward pleat tip 212 of the end pleat-panel 211, can have advantageous effects.

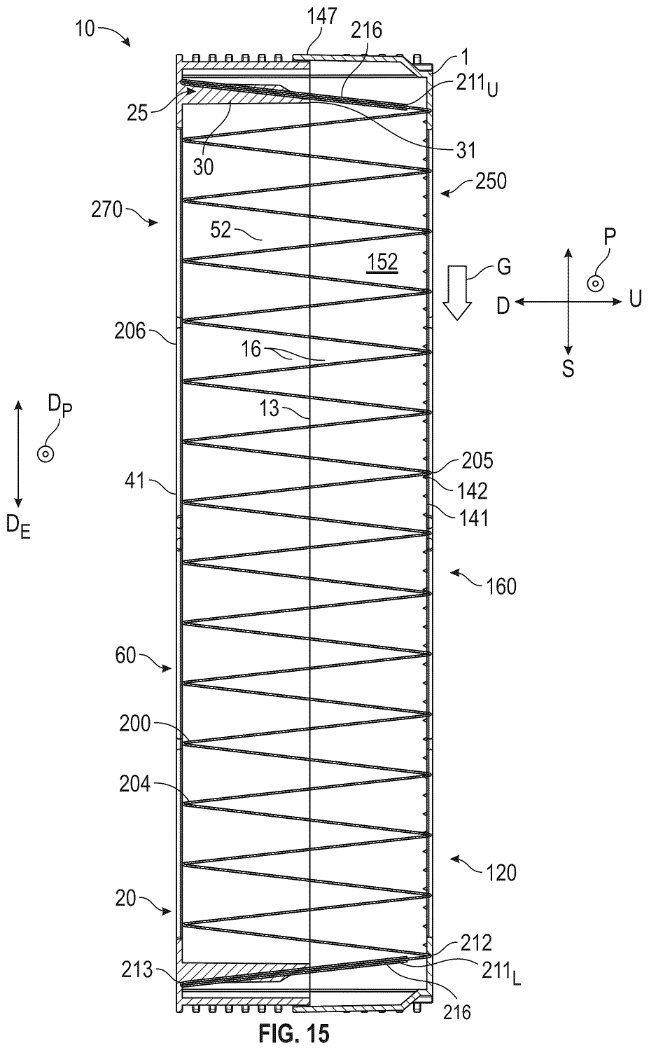

In further detail, even though a primary purpose of elongate members 600 is to limit the expansion of pleated air filter 200 to range that establishes a desired pleat spacing, in some instances elongate members 600 may also help support the weight of the pleated air filter. (This may be relevant e.g. if a framed air filter 10 is installed in a powered air-handling system in an orientation such that the expansion direction of the pleated air filter is vertical, as in the exemplary depiction of FIG. 15, discussed in detail later herein.) The present investigations have found that if an upward portion of a reinforcing sheet 300 is positioned relatively close to a location 618 at which an elongate member 600 is bonded to the upward pleat tip 212 of the end pleat-panel 211, the presence of this portion of the reinforcing sheet may minimize any tendency of the upward portion of the end pleat-panel (in particular, a portion that may extend at least slightly out of the previously-described elongate slot 25) to deform due to the weight of the pleats that are below it (this scenario is primarily applicable to an uppermost end pleat-panel 211_{U} as seen in FIG. 15, rather than for a lowermost end pleat-panel 211_{L} as also seen in FIG. 15). And, the presence of the bonded elongate member 600 close to this portion of the reinforcing sheet can allow the elongate member to similarly support the other upward pleat tips to which the elongate member is bonded (i.e., the upward pleat tips that are vertically lower than pleat tip 212), so that these additional upward pleat tips are less likely to sag due to their weight and/or the weight of the material above and/or below them.

It has thus been found that positioning a reinforcing sheet 300 so that an upward edge 318 of the reinforcing sheet is within e.g. 2.5, 2.0, 1.5, 1.0, or 0.5 cm of a location 618 at which a pleat-spacing-limiting elongate member 600 is bonded to the upward pleat tip 212 of the end pleat-panel 211, can advantageously help support the weight of the pleated air filter. It might be considered that an outward segment 304 of a reinforcing sheet, 300, mounted on an outward face 214 of the end pleat-panel 211, or an inward segment 305, mounted in an inward face 215 of the end pleat-panel 211, would be equally effective in this regard. However, the present investigations have found that an inward segment 305, on an inward face 215 of the end pleat-panel, seems to be more effective. An arrangement of the general type depicted in FIG. 13, in which elongate members 600 are bonded to upward pleat tips 212 at locations 618 that are spaced away (along the pleat direction of the air filter) from the above-described notch 317 in inward segment 305, allows the upward edge 318 of inward segment 305 to be positioned very close to bonding locations 618 as evident in FIG. 13. (In FIG. 13, the distance, along the end pleat-panel, between an upward edge 318 of an inward segment 305 and a bonding location 618 of a member 600 to an upward pleat tip 212, is denoted by reference number 619.)

Such arrangements may e.g. augment certain other arrangements (described later herein) by which any tendency of a pleated air filter to sag under its own weight can be mitigated. Any such arrangements may be particularly relevant when the framed air filter is oriented so that the expansion direction of the pleated air filter is vertical; such arrangements may be particularly beneficial for so-called deep-pleat air filters, which (having a pleat height of from two inches up to six inches, often about four inches), comprise a relatively high weight per nominal unit area.

Astute observers will realize that the arrangements described above may only be realized in full for the upward end of the end pleat-panel (i.e., near upward pleat tip 212) and its associated reinforcing sheet and elongate member(s). That is, since the downward tip 213 of end pleat-panel 211 may not have any elongate member(s) 600 attached to it (so that a downward section of end pleat-panel 211 can be inserted into an elongate slot of a filter frame as discussed elsewhere herein), it may not be possible to directly provide this type of support for the downward pleat tips 206 of pleated air filter 200, over the entire length of the air filter including the end pleat-panels. Nevertheless, the present investigations have found that providing, by way of an upward elongate member 600c, such support only for the upward pleat tips (including that of the end pleat-panel) can nevertheless have a discernable effect on minimizing any sag not only of the upward pleat tips, but also of the pleated air filter as a whole. (Such effects may be augmented by the presence of a downward elongate member 600D, even though such a downward member may not necessarily be attached to the end pleat-panels 211 of the air filter.) It will be further noted that refraining from attaching an elongate member 600 to a downward tip 213 of an end pleat-panel 211 may only be applicable in instances where the end pleat-panel 211 is a reinforced pleat-panel that is used as a securing tab 216. In other arrangements (e.g. when a piece of sheet-like reinforcing material that extends well beyond the terminus of the end pleat-panel is used as a securing tab), this restriction may not be necessary.

Filter media 400 and reinforcing sheet 300 (e.g. both its inward segment 305 and its outward segment 304) will exhibit a width in a direction that is parallel to the pleat direction of the pleated air filter. In some embodiments, some or all portions of reinforcing sheet 300 may be configured so that the width of reinforcing sheet 300 is less than the width of filter media 400, as depicted in exemplary embodiment in FIGS. 9-10 and in particular in FIG. 13. This may be done for similar reasons as discussed earlier herein with regard to having a stiffening layer 500 be similarly configured to be narrower than the filter media 400. That is, filter media 400 may comprise a small amount of “extra” material 405 that extends beyond the edges 303 of reinforcing sheet 300, e.g. so that the “extra” material 405 of filter media 400 can exhibit a self-sealing characteristic in the general manner discussed earlier herein.

Thus in various embodiments, secondary edges 403 of filter media 400 may extend outward beyond the edges 303 of reinforcing sheet 300 a distance of at least 2, 3, 4, 6 or 8 mm. In further embodiments, secondary edges 403 of filter media 400 may extend outward beyond edges 303 of reinforcing sheet 300, a distance of no more than 30, 25, 20, 15 or 10 mm.

In some embodiments, one or both securing tabs 216 (e.g., reinforced end pleat-panels 211) of a pleated air filter 200 may comprise an outward-facing indicator zone 375, located e.g. in a downward section of the reinforced end pleat-panel, as depicted in exemplary embodiment in FIGS. 9 and 13. When the pleated air filter 200 is properly installed in a frame, the indicator zone 375 will be visible through a window 75 in a downward section of an outward primary sidewall of a primary portion of the frame, and can provide confirmation that the securing tab is properly seated in an elongate slot 25 of the frame. Such an indicator may take any suitable form and may rely on any suitable informational scheme. Examples include color (e.g. the indicator zone 375 may comprise a green indicia), shape (e.g. the indicator zone 375 may comprise a check mark), and so on. In some embodiments (as in the exemplary arrangements of FIGS. 9 and 13), indicator zone 375 may be on an outward segment 304 of a reinforcing sheet 300 that is mounted on an end pleat-panel of the pleated air filter media.

Discussions above have concerned exemplary embodiments in which a securing tab 216 is provided by an end pleat-panel (or multiple gathered pleat-panels) 211 of pleated filter 200, the end pleat-panel being reinforced e.g. by way of a sheet-like reinforcing material 300 that is mounted on the end pleat panel. In such embodiments, this end pleat-panel 211 (or, at least a significant portion thereof) will be the entity that is inserted into an elongate slot 25 of frame base 20 to secure the pleated air filter 200 to the frame base 20. In some such embodiments, the sheet-like reinforcing material 300 may not extend beyond the end pleat-panel excepting a small extent (e.g. less than 2.0 mm) to which apex 313 of reinforcing sheet 300 resides slightly downward of the terminus 213 of the end pleat-panel 211 in the manner described earlier herein. However, in some embodiments, an end pleat-panel could be relatively short such that a major portion of the piece of reinforcing sheet 300 extends well beyond the terminus of the end pleat-panel. In other words, an end pleat-panel can be configured (e.g. by being deliberately cut short) so that the pleat distance P_{D} (as identified in FIG. 12) of the end pleat-panel is, e.g., no more than 90, 70, 50, or 30% of the pleat distance P_{D} of the other, interior (non-end) pleat-panels of the pleated filter 200. In some such cases, only a relatively small portion of the end pleat-panel may become seated in the elongate slot 25 of the frame base 20. In a further variation of such an approach, a piece of sheet-like reinforcing material 300 may extend so far beyond the terminus of the end pleat-panel of the pleated air filter that no portion of the end pleat-panel (or of any gathered pleat-panels) of the pleated air filter will become seated in the elongate slot 25 of the frame base 20. In such a case, the piece of sheet-like reinforcing material may serve as the securing tab. In some embodiments of this general type, an end pleat-panel 211 may terminate proximate an upward side of the pleated air filter, with the piece of sheet-like reinforcing material being attached to the end pleat-panel 211 and having at least one bend that suitably places a major portion of the piece of sheet-like reinforcing material in a suitable orientation to be inserted generally downward into an elongate slot 25 of the frame base. All such arrangements are encompassed within the herein-disclosed concept of using a securing tab to secure a pleated air filter to a frame base.

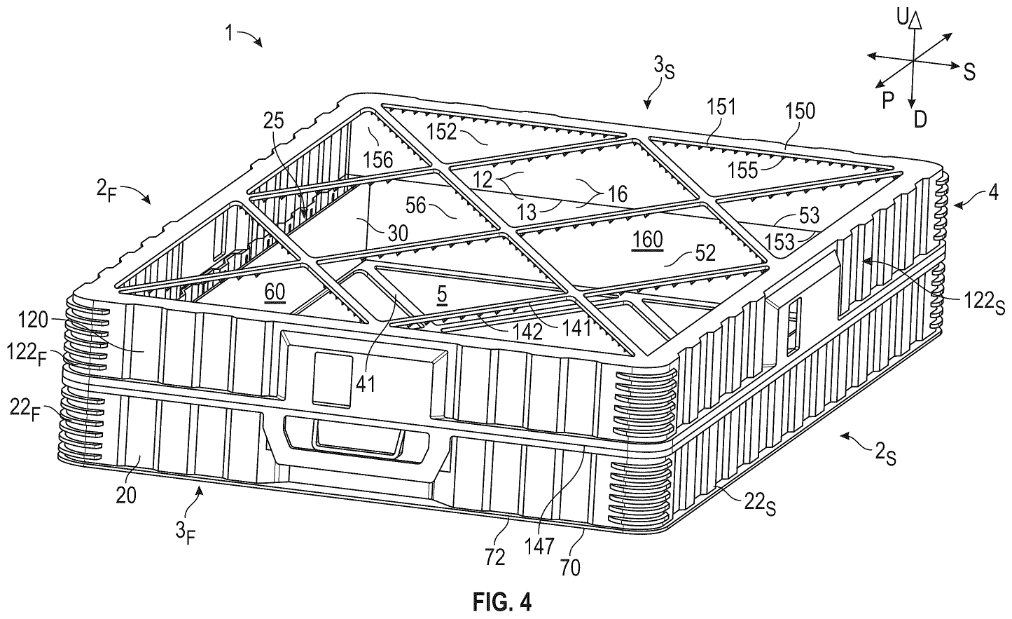

Returning to frame 1, reusable frame 1 may comprise a frame base 20 and a frame cover 120 that can be mated and attached to each other to form frame 1 as discussed briefly earlier herein. Frame base 20 and frame cover 120 are shown detached from each other (in the absence of pleated air filter 200) from the upward side in FIG. 2 and from the downward side in FIG. 3. Frame base 20 will comprise first and second opposing primary portions 22_{F} and 22_{S} and first and second secondary portions 23F and 23s. Frame cover 120 will similarly comprise first and second opposing primary portions 122_{F} and 122_{S} and first and second secondary portions 123_{F} and 123_{S}. When the frame base and frame cover are brought together (as depicted in FIG. 4, with air filter 200 not shown), the first and second primary portions of the frame base and the frame cover will collectively provide the first and second primary portions 2_{F} and 2_{S} of frame 1, and the first and second secondary portions of the frame base and the frame cover will collectively provide the first and second secondary portions 3_{F} and 3_{S} of frame 1.

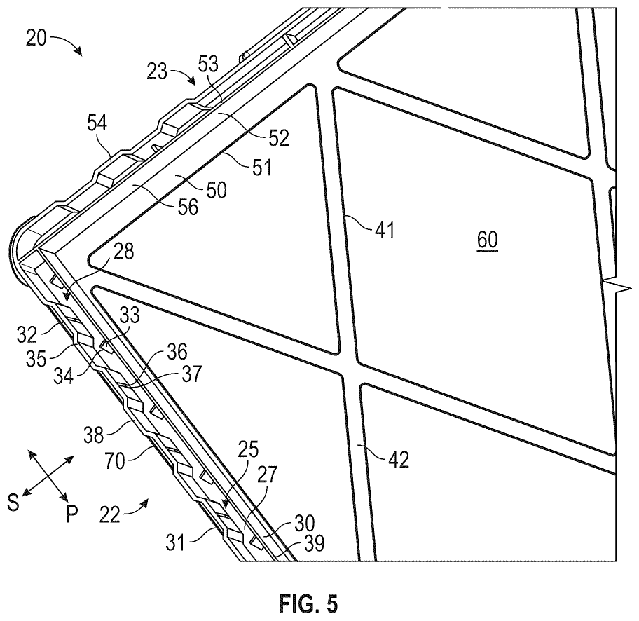

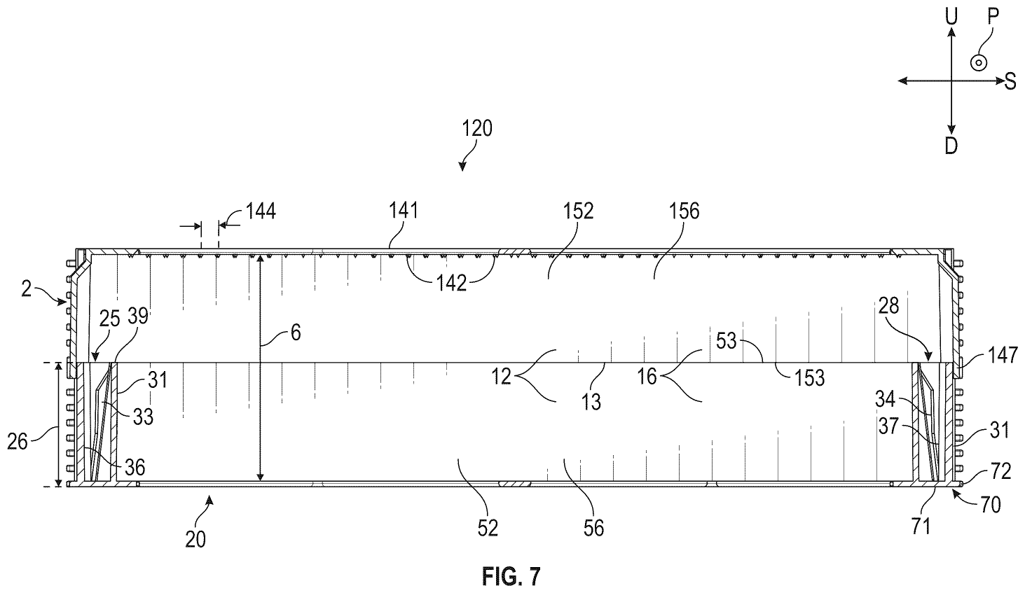

In the depicted embodiment, the first and second opposing primary portions 22_{F} and 22_{S} of frame base 20 respectively comprise first and second upward-open-ended elongate slots 25_{F} and 25_{S}. An exemplary such slot 25 is most clearly visible in the perspective view of FIG. 4, and in FIG. 5, which is a magnified view of a corner portion of an exemplary frame base 20. Each such upward-open-ended elongate slot 25 will have a long axis that is aligned with the frame's primary axis/direction (again, denoted by axis “P” in various Figures) of the frame. Each slot 25 will have an upward end 28 that is open and a downward end that is at least partially (e.g. fully) closed, e.g. by way of being provided with a slot floor 27 as indicated in FIG. 5. Each slot 25 will have a slot depth 26 that extends in a generally downward direction from its open upward end 28 to the slot floor 27. Slot depth 26 is pointed out in FIG. 7, which is a cross-sectional view of frame 1, looking along the primary direction of the frame. Two such slots 25 are present, each such slot 25 being configured to receive a securing tab 216 of a primary end 202 of pleated air filter 200, so that the first and second securing tabs of the air filter can be respectively securely seated within first and second slots 25 to install air filter 200 in frame base 20. With this done, frame cover 120 can be brought into position and attached to frame base 20 to provide a framed air filter 10.

The seating of securing tabs 216 of opposing primary ends 202 of pleated air filter 200 into upward-open-ended elongate slots 25 can allow the pleated air filter to be held in place on the frame, in spite of any force that is exerted on the air filter by the impinging of flowing air on the upstream surface of the air filter.

In at least some embodiments, this can be achieved without having to use any additional attachment methods such as adhesively bonding the reinforced end pleat-panels to the frame, or, in general, without adhesively bonding or mechanically fastening (such as with staples) any portion of the air filter to any portion of the frame. In the depicted embodiment, each upward-open-ended elongate slot 25 of frame base 20 is inwardly bounded by an inward primary sidewall 30 of a primary portion 22 of frame base 20, and is outwardly bounded by an outward primary sidewall 31 of primary portion 22, as evident e.g. in FIGS. 2 and 4. An upward edge 39 of inward primary sidewall demarcates the upward-facing, open end 28 of slot 25, as evident e.g. in FIGS. 2 and 7.

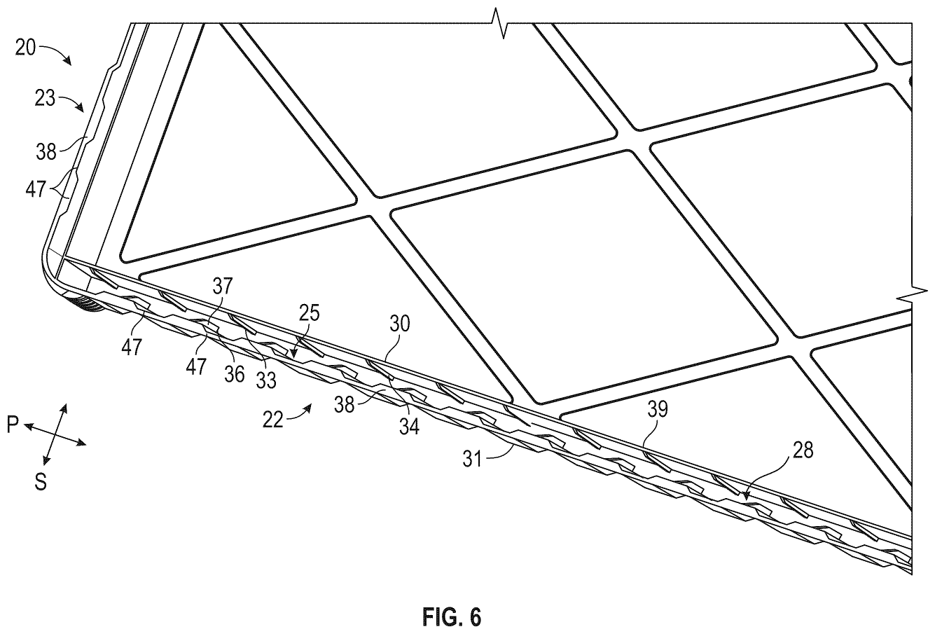

In some instances, a slot 25 may comprise features that increase the tightness with which a securing tab 216 (e.g. a reinforced end pleat-panel 211) of an air filter is held in the slot. In the depicted embodiment, this is provided in the form of ribs 33 that extend outwardly from inward primary sidewall 30, and ribs 36 that extend inwardly from outward primary sidewall 31. Exemplary sets of such ribs are depicted in FIGS. 5 and 6. As evident from these Figures, in some embodiments, ribs 33 and 36 may alternate along the elongate length of slot 25. In some embodiments, ribs 33 and/or ribs 36 may be tapered, meaning that they are narrower toward the open end 28 of the slot (and may disappear completely near the open end) and protrude further into the interior of the slot (along a generally inward-outward direction of the frame portion) toward the bottom of the slot. Such arrangements (which are particularly noticeable in FIG. 6) can provide that as a reinforced end pleat-panel of an air filter is pushed more deeply into the slot, the pleat-panel is held more and more tightly, which may provide useful haptic feedback to an end-user as to whether the end pleat-panel is fully seated in the slot. Ribs 33 and 36 may respectively comprise contact surfaces 34 and 37 that are configured to contact the inward and outward faces of the reinforced end pleat-panel. Thus in some embodiments, a downward section of the reinforced end pleat-panel may be held in a friction-fit between outward contact surfaces of outwardly-extending ribs and inward contact surfaces of inwardly-extending ribs. (In FIG. 15, no attempt is made to show the downward section of the reinforced end pleat-panel exactly as held by the outwardly-extending ribs and inwardly-extending ribs; similarly, in FIG. 15, other items such as e.g. the previously-described elongate members 600 are not depicted so that other items and their relationships may be more easily seen).

As evident e.g. from FIG. 5, an inward primary sidewall 30 that outwardly bounds a slot 25 of frame base 20 can be at least generally or substantially planar. In contrast, again as evident from FIG. 5, in some embodiments an outward primary sidewall 31 that outwardly bounds a slot 25 of frame base 20 can be corrugated so as to have alternating inward panels 32 and outward panels 35. (Indeed, in many embodiments, all of the outward primary sidewalls and outward secondary sidewalls of frame base 20, and/or of frame cover 120, may be similarly corrugated, as evident e.g. from FIGS. 1 and 4.) In some such embodiments, ribs 36 may extend inwardly from inward panels 32 of outward primary sidewall 31, again as evident from FIGS. 5 and 6. Ribs 33 may then be positioned so that each rib 33 extends outwardly from an area of inward primary sidewall 30 that is across from an outward panel 35 of corrugated outward primary sidewall 31, similarly evident in FIGS. 5 and 6. Positioning ribs 36 and 33 in this manner can provide that ribs 36 can help (in combination with ribs 33) to hold a reinforced end pleat-panel securely in slot 25, even if ribs 36 do not protrude very far inward into slot 25 (as in the exemplary design of FIG. 5).

The above discussions illustrate how elongate, upward-open-ended slots 25 of primary portions 22 of frame base 20 can receive securing tabs 216 of a pleated air filter 200 in order to install the pleated air filter into the frame base. Frame base 20 may comprise various features and arrangements that (e.g. with framed air filter 10 installed in a receptacle of a powered air-handling apparatus so that the downward side of the framed air filter is the downstream side) can provide that pleated air filter 200 remains securely in place and does not, for example, unacceptably deform (e.g., billow or balloon) downstream due to the air pressure developed by an airstream impinging on the upstream face of the pleated air filter. Such support features can include e.g. first and second opposing downward support flanges 50 that extend inward from downward ends of opposing inward secondary sidewalls 52 of secondary portion 23 of frame base 20, as seen e.g. in FIG. 5. Each such support flange 50 can support a secondary end portion of pleated air filter 200, along the secondary, corrugated edges 203 of the air filter. Specifically, the downward pleat tips 206 of the corrugated edges 203 of pleated air filter 200 may rest on or against the upward surface of support flange 50. The inward edges 51 of the downward support flanges 50 will define the secondary outer edges of a downward air-filtration area 60 defined by the frame base 20. (The primary outer edges of downward air-filtration 60 may be defined by the downward ends of the above-described inward primary sidewalls 30; or, by a slight inwardly-protruding “lip” (unnumbered, but visible e.g. in FIG. 5) at the downward end of inward primary sidewall 30.)

In some embodiments, frame base 20 may provide other downward support for air filter 200. For example, frame base 20 may comprise a set of downward struts 41 that collectively form a downward support lattice 40. In many embodiments, struts 41 will be integral with frame base 20. Struts 41 are sized and spaced so that they provide downward support for air filter 200 against e.g. billowing or deformation, but so that they also present a high percent open area so allow adequate airflow. The exemplary illustrations herein depict struts 41 that are linear and are present in two sets of parallel struts, oriented so as to provide air-transmissive openings that are diamond-shaped. However, such struts can be of any suitable size, orientation, spacing, etc., and do not necessarily have to be straight along their entire length. In various embodiments, such struts may be arranged in a square array, a hexagonal array, and so on.

In the depicted exemplary arrangements visible e.g. in FIGS. 2, and 5, downward struts 41 of downward lattice 40 comprise upward faces 42 that are planar; specifically, struts 41 do not have any protrusions that protrude in an upward direction from upward face 42. This can be contrasted with the numerous protrusions 142 that protrude downward from struts 141 of upward lattice 140, as evident e.g. in FIGS. 3, 4 and 6. Such an arrangement may be particularly advantageous as discussed later herein.

As disclosed herein, a pleated air filter 200 can be installed into frame base 20 so that the securing tabs 216 of the air filter are seated in elongate slots 25 of the frame base. In practice, this may be easily done e.g. by placing frame base 20 on a horizontal surface (e.g. a tabletop or countertop) so that the open ends 28 of slots 25 of the frame base face generally upward, positioning air filter 200 within the partial-receptacle defined by frame base 20, and securing air filter 200 on frame base 20 by of inserting securing tabs 216 (e.g. reinforced end pleat-panels 211) generally downward into the corresponding elongate slots 25 of the frame base. As noted earlier, this mode of installation is the basis for the terminology of “upward” and “downward” directions as used herein. However, again as noted earlier, this terminology is used for convenience of description and does not limit the orientation that the various items can be placed in. For example, in some instances a frame base might be placed so that it stands vertically, end-wise, on a horizontal tabletop, with an air filter being inserted into the frame base while the frame base is in this vertical orientation. With air filter 200 installed in frame base 20 (however achieved), frame cover 120 can then be moved (e.g. vertically lowered) into position on frame base 20. Frame cover 120 and frame base 20 can then be attached to each other, e.g. with a system of latch members 124 and latch catches 24 as noted earlier herein.

Bringing frame base 20 and frame cover 120 together in this manner thus defines the complete frame 1. Various sections, items and components of the base and cover will combine to provide various features and functionalities of frame 1. For example, frame base 20 comprises two opposing inward secondary sidewalls 52 and frame cover 120 similarly comprises two opposing inward secondary sidewalls 152. When the base and cover are joined, the upward edge 53 of each sidewall 52 of the base may meet the downward edge 153 of each sidewall 152 of the cover, at junction 13, to collectively form an inward secondary sidewall 12 of frame 1, as indicated in FIGS. 4 and 7. In many embodiments, sidewalls 52 and 152 will respectively comprise inward surfaces 56 and 156 that are continuous and planar; the thus-formed inward secondary sidewall 12 of the assembled frame 1 will consequently comprise an inward surface 16 that is continuous and planar in the manner evident e.g. in FIGS. 4 and 7. In the depicted embodiment, the junction 13 between the upward edge 53 of each inward secondary sidewall 52 of frame base 20 and the downward edge 153 of each inward secondary sidewall 152 of frame cover 120, is a simple edge-to-edge butt junction. Nevertheless, these arrangements (e.g., as used in combination with any other arrangements disclosed herein) have been found satisfactory; it has not been found necessary to, e.g., include any gasketing, caulking, adhesive, or sealing material at junction 13.

The outward primary and secondary sidewalls 31 and 54 of frame base 20, and the outward primary and secondary sidewalls 131 and 154 of frame cover 120, will similarly be brought together to form the outward primary and secondary sidewalls of frame portions 2 and 3 of the thus-formed frame 1. Further details, and advantageous features and arrangements, regarding these items will be discussed later herein. With pleated air filter 200 thus installed in frame 1, at least some portions of the first and second opposing outward, corrugated (secondary) edges 203 of pleated air filter 200 may closely abut (e.g. within 1.0, 0.5, or 0.2 mm) the above-described first and second opposing inward surfaces 16 of inward secondary sidewalls 12 of secondary frame portions 3. In some embodiments, at least some portions of these corrugated edges 203 may be in contact with some portions of inward surfaces 16. In some embodiments a resilient gasketing material (e.g. a strip of resilient foam or fibrous material, e.g. with an adhesive backing so as to attach the strip to inward surface 16) may be provided on inward surface 16 of frame 1 to minimize any air leakage around the corrugated edges of the air filter. However, so far this has not been found to be necessary due to the efficacy of various other arrangements described herein; thus, in some embodiments, no gasketing, caulking, sealing, or space-filling material (whether as an adhesive-backed strip or of any other construction) need be provided on surface 16 of frame 1.

Among the beneficial arrangements described herein is configuring the corrugated edges 203 of a pleated air filter 200 so that corrugated-edge portions of a compliant filter media 400 of the air filter extend outward beyond the secondary edges 503 of a stiffening layer 500 (and, optionally, beyond the secondary edges of reinforcing sheets 300 on end pleat-panels 211 of the air filter) so that the corrugated-edge portions 404 of the compliant filter media can conform to the inward surfaces 16 of the above-described inward secondary sidewalls 12 of the frame, so that the corrugated edges of the compliant filter media self-seal against inward surfaces 16. The usefulness of having inward surface 16 be continuous and planar (i.e., without any through-holes, cavities, divots or the like through which air could leak to bypass the corrugated edges of the air filter) can thus be appreciated. Other aspects of frame 1 can be arranged to enhance such effects. For example, frame 1 can be configured so that the width 7 of filter receptacle 5 (shown in FIG. 8) is slightly less than the width of filter media 400 (along the pleat direction) to ensure that the secondary-edge portions 404 of filter media 400 can perform the desired self-scaling function.

The above arrangements can minimize air leaks e.g. around the edges of air filter 200 within frame 1, in order to enhance filtration performance. It is also possible to enhance filtration performance by minimizing any air leaks around the outside of frame 1. Such arrangements may be used in combination with the above arrangements, or may be beneficial even if used in isolation. For example, in some embodiments frame base 20 may comprise a downward scaling apron 70 with a downward face 71 that is planar and that extends around the entire perimeter of the frame base (as most easily seen in FIG. 3) and that has an outward edge 72. Apron 70 may be arranged so that no portion of frame base 20 is positioned downward of downward face 71 of apron 70 and so that no portion of frame base 20 is positioned outwardly of the outward edge 72 of downward face 71 of apron 70. This can provide that when the framed air filter 10 is inserted into a filter-receptacle of a powered air-handling apparatus (in a standard configuration as discussed elsewhere herein), much or all of the downward face 71 of frame 1 can be in firm contact with a surface of a flange, fixture, etc. of the filter-receptacle of the air-handling apparatus. (In fact, downward/downstream face 71 will tend to be held against such a surface by the pressure developed by the air impinging on the upward/upstream face of the framed filter.) Downstream face 71 of downstream scaling apron 70 may thus establish a reasonably air-tight seal against the filter-receptacle of the air-handling apparatus. And, apron 70 being the farthest-downstream component of frame 1, apron 70 will establish a “dead-end” path so that any (potential) air leakage that does occur e.g. around the outward edges of the frame, will have nowhere to go. Such arrangements can further enhance the filtration performance.

Another feature which may be useful in some instances is a skirt 147 (as denoted e.g. in FIGS. 2 and 3) that extends completely around the entire perimeter of the downward edge of all of the outward sidewalls of frame cover 120, and protrudes downward from this downward edge. Such a skirt 147 may be configured so that when frame cover 120 is mated to frame base 20, at least a portion of skirt 147 outwardly abuts an upward edge 38 of an outward sidewall of frame base 20. Such arrangements may help minimize any air leaks at the junction between the upward edges 38 of the outer primary and secondary sidewalls 31 and 54 of frame base 20, and the downward edges of the corresponding primary and secondary sidewalls of frame cover 120. In some embodiments, the upward edges 38 of the outward primary and secondary sidewalls of frame base 20 may comprise a “lip” 47 (shown in FIG. 6) that has a planar and continuous outward surface that can be outwardly abutted by an inward surface of skirt 147 of frame cover 120. Such arrangements may provide anti-leak enhancements in some circumstances. However, they may not be needed in all cases (no such lip is present in the exemplary embodiment of FIG. 5), e.g. if a downward scaling apron 70 is present as described above. Including an outward skirt 147 along the downward perimeter of frame cover 120 in the general manner described above can also advantageously provide that when the first and second securing tabs 216 of the air filter are installed in the frame base 20 and the frame cover 120 is brought into position onto the frame base 20, the primary portions of skirt 147 will be positioned outward of the upward ends 212 of the securing tabs 216 all along the upward ends 212 of the securing tabs 216. This can allow the primary portions of skirt 147 to guide the upward ends 212 of the securing tabs (e.g. reinforced end pleat-panels 211) into their proper position within the filter-receptacle 5 of the thus-formed frame 1.

In some embodiments, frame cover 120 may comprise a set of upward struts 141 that collectively form an upward lattice 140. Struts 141 and lattice 140 may be very similar to downward struts 41 and downward support lattice 40; for example, upward struts 141 may be integral with frame cover 120, may be sized and spaced to comprise a high percent open area, and so on. Indeed, in the depicted embodiment, upward struts 141 are near-identical to downward struts 41. But, being on the upstream side of frame 1 (if framed air filter 10 is installed in a standard configuration as discussed elsewhere herein), upward struts 141 may not necessarily provide support for air filter 200 in terms of helping air filter 200 to resist deformation from the air pressure of the impinging airflow. However, the present investigations have found that upward struts 141 can be configured to play a beneficial role, albeit a role that may be different than the role played by downward struts 41. Specifically, upward struts 141 can be equipped with a multiplicity of protrusions 142 (as seen most easily in FIGS. 3, 4 and 7) that protrude at least generally downward from the downward faces of struts 141 of upward lattice 140, and that are spaced along a secondary direction of the frame and thus along an expansion direction of the pleated air filter 200.

The role of such protrusions is as follows. In some situations a framed air filter 10 may be installed in a receptacle of a powered air-handling system in an orientation such that the expansion direction of the pleated air filter is vertical. Such a scenario is depicted in exemplary manner in FIG. 15, which is a cross-sectional view looking along the primary direction P_{D} of the frame and along the pleat direction D_{P} of the pleated air filter. In FIG. 15, the airflow is from right to left so that the upstream side of the framed filter is to the right and the downstream side of the framed filter is to the left. The framed filter is installed so that the expansion direction D_{E} of the pleated media is vertically aligned so that the force of gravity is along the expansion direction as indicated by arrow G in FIG. 15. In such a situation, at least some pleats of the air filter may tend to sag under their own weight and/or the weight of the other pleats that they are connected to. (Deep-pleat filters may be particularly susceptible to this.) While the pleated air filter may still remain securely within frame 1 (with the end pleat-panels seated in the elongate slots of the frame), such deformation may nevertheless affect the air-filtration performance at least somewhat.

If a pleated air filter 200 is installed in a frame 1 as disclosed herein, at least some portions of at least some of the upward pleat tips 205 of the pleated air filter will closely abut the downward side of upward struts 141. With protrusions 142 present, at least some such upward pleat tips 205 can each contact, and thereby be supported by, a protrusion 142. For example, an upward pleat tip 205 may rest vertically atop a protrusion 142. This scenario is illustrated by the particular upward pleat tip 205 and protrusion 142 denoted in FIG. 15. Protrusions 142 are thus referred to herein as anti-sag protrusions with upward lattice 140 being termed an anti-sag lattice. In many embodiments, anti-sag protrusions 142 will be integral with upward struts 141 (in many embodiments, frame cover 120, including its primary and secondary portions, sidewalls, latch members and so on, and struts 141 and anti-sag protrusions 142 thereon, may be formed as a single, integral, unitary entity in a single injection-molding operation).

The present investigations have found that there seems to be no need to locate anti-sag protrusions 142 at particular positions along struts 141 in an attempt to have each anti-sag protrusion located exactly where an upward pleat tip 205 of the air filter is expected to contact it. Rather, a simpler approach has been found to be effective, in which a large number of protrusions 142 is used (e.g., a number in excess of the number of upward pleat tips 205 of the air filter) as evident e.g. from FIG. 15. The protrusions 142 can be spaced along the secondary direction of the frame, and along the expansion direction of the pleated air filter 200, at a spacing that is smaller than the pleat spacing of the pleated air filter, again as evident from FIG. 15. Any upward pleat tip will only be able to sag a limited distance before it encounters a protrusion 142 that helps prevent the pleat tip from sagging further. (The approach is thus one that seeks to limit the maximum sag that can be experienced by each upward pleat tip, rather than seeking to completely eliminate such sag for every individual pleat tip.) In some embodiments, the protrusions 142 that are on one strut 141 may be offset (along the previously-described length direction of frame 1) from the protrusions 142 that are on another strut 141, the spacings of the protrusions 142 along the different struts 141 may be varied, and so on. This can further provide that any upward pleat tip 205 that begins to sag will encounter an anti-sag protrusion 142 somewhere along the elongate length of the upward pleat tip before having sagged very far.

In various embodiments, anti-sag protrusions may be provided at an average spacing along the secondary direction of the frame cover, that is at most 90, 80, 70, 60, 50, or 40% of the pleat spacing of the pleated air filter. (All such pleat spacings are with the pleated air filter in its expanded, in-use condition.) In further embodiments, the anti-sag protrusions may be provided at a spacing that is at least 10, 20, or 30% of the pleat spacing. (By way of a specific example, if the pleat spacing is 2.4 cm, the protrusion spacing may be e.g. 1.0 cm, in which case the above-described ratio is thus approximately 40%.) The pleat spacing need not necessarily be an integral multiple of the protrusion spacing, although it can be if desired. In various embodiments, the anti-sag protrusion spacing may be, on average, at least 2, 4, 6 or 8 mm. In further embodiments, the anti-sag protrusion spacing may be, on average, at most 2.5, 2.0, 1.5, 1.2, or 1.0 cm.

To further enhance such effects, in some embodiments the secondary frame portions 123 of frame cover 120 may comprise upward anti-sag flanges 150 that extend inward from upward ends of opposing inward secondary sidewalls 152 of the secondary frame portion. These upward anti-sag flanges may each comprise a multiplicity of anti-sag protrusions 155 that protrude in a downward direction from the downward face of the upward anti-sag flange and that are spaced along the secondary direction of the frame. (Such anti-sag protrusions 155 of flanges 150 are visible e.g. in FIG. 3; in the depicted embodiment, the anti-sag protrusions 155 of flanges 150 are near-identical to the anti-sag protrusion 142 of struts 141, but this does not have to be the case.) Anti-sag flanges 150, as equipped with anti-sag protrusions 155, may similarly contribute to minimizing any sagging of the pleated air filter. In many embodiments, the inward edges 151 of the upward anti-sag flanges 150 will define secondary edges of an upward air-filtration area 160 defined by the frame cover.

Protrusions 142 and 155 can have any suitable downward extent. In various embodiments, they may protrude downward at least 0.4, 0.8, 1.2, 1.8, 2.4, or 2.8 mm from the downward face of their source strut or flange. In further embodiments, they may protrude at most 8.0, 6.0, 3.0, 2.5, 2.0, or 1.5 mm. In the depicted embodiment, protrusions 142 and 155 are depicted as ribs that are elongated generally along the along the primary direction of the frame (and thus are elongated along the pleat direction of air filter 200). However, in various embodiments, such protrusions can take any form, e.g. a post or column, a row of posts, and so on. Comparison of FIGS. 3 and 9 reveals that in the depicted exemplary arrangements, anti-sag protrusions 142 are not present at locations of struts 41 that will closely abut a pleat-spacing-limiting member 600 when air filter 200 is installed in frame 1. (One such location at which protrusions 142 are purposefully omitted, is denoted as location 143 in FIG. 3.) Such arrangements can ensure that members 600 do not snag on protrusions 142 and that protrusions 142 do not otherwise interfere with the functioning of members 600. Such arrangements have not been found to adversely affect the ability of the remaining protrusions 142 (e.g. along with protrusions 155) to perform their anti-sag function.

In the depicted embodiments, no anti-sag protrusions equivalent to protrusions 142 or 155 are shown on the downward struts 41 or on the downward support flanges 50, of frame base 20. In some embodiments, anti-sag protrusions may be provided in either such location as discussed in detail below. However, the present investigations have found that providing the anti-sag functionality on the upward side of the pleated air filter seems to be adequate for minimizing any sagging of the pleated air filter in most circumstances. Furthermore, it has been found that end-users often prefer to install a pleatpack into a frame base by positioning the frame base on a horizontal surface, inserting the pleatpack into the partial-receptacle defined within the frame base, and inserting a first reinforced end pleat-panel of the pleatpack into an elongate slot of the frame base. After this, the end-user will expand the pleatpack into its fully expanded, in-use configuration, and insert the second reinforced end pleat-panel into the other elongate slot of the frame base. Even if the end-user partially expands the pleat-pack before inserting the pleatpack into the partial-receptacle, end-users seem to often end up performing at least some expansion of the pleatpack after the pleatpack has been inserted into the partial-receptacle and a first reinforced end pleat-panel has been seated into a first slot of the frame. If the downward struts 41 and/or downward support flanges 50 comprised upward anti-snag protrusions, such protrusions might interfere somewhat with the ability to fully expand the pleatpack. (In other words, the downward pleat tips might snag on the protrusions as the pleat tips move along the expansion direction.) This being the case, and upward pleat-tip support so far seeming adequate to the task of minimizing sagging of the pleated air filter, the presently preferred arrangement is to provide anti-sag protrusions only on the upward struts of the frame cover and not on the downward struts of the frame base. (In such an arrangement, the anti-sag protrusions cause no problem with snagging, since the frame cover is not mated to the frame base until the pleatpack has already been fully expanded.) However, in some embodiments it may be desirable to provided downward anti-sag protrusions, e.g. on the upward sides of downward lattice struts 41 and/or on the upward sides of downward support flanges 50. In such a case, an end-user may be instructed to, e.g., fully expand the pleated air filter 200 before its reinforced end-panels are inserted into the respective slots of the frame base, so that the downward pleat tips do not snag on the downward anti-sag protrusions during installation of the air filter into the frame base. Or, an end-user may be instructed to lift the air filter 200 slightly away from the frame base as it is expanded, to ensure that the downward pleat tips of the air filter do not snag or catch on the downward anti-sag protrusions.

In some embodiments, any such anti-sag protrusions may be configured to easily allow pleat tips to slide by in an expansion direction, but to oppose any ability of the pleat tips to move in an opposing (sagging) direction. For example, such anti-sag protrusions might be configured in a sawtooth or ramped pattern, in which each protrusion comprises a lower portion (i.e., vertically lower, when the framed air filter is installed in a vertical orientation in a receptacle of a powered air-handling apparatus) that is ramped so as to have a gradual slope. The ramped portion (and thus the protrusion) may terminate at its top in a generally horizontal shelf (or a reverse slope, e.g. so that the protrusion resembles a fishhook barb). Such an anti-sag protrusion can allow pleat-tips to slide by easily in the expansion direction; however, any attempted movement of the pleat-tips in the opposite direction (e.g., sagging) will be opposed. (In other words, the pleat-tips, if they start to sag, will “snag” on the anti-sag protrusions.)

It will be appreciated that any such arrangement, while not necessarily requiring that the pleated air filter must be fully expanded before being installed and/or requiring the air filter to be lifted away from the frame base while being expanded, may require that preferential orientations of the frame base and the pleated air filter be established for purposes of inserting the air filter into the frame base. In other words, an end-user may be instructed to insert a reinforced edge-panel of the air filter in a slot at a specific primary end of the frame base, so that the expansion of the air filter occurs along a direction (e.g. along the ramped portions of the anti-sag protrusions) that allows the desired expansion. This primary end of the frame base will also be the vertically lower end of the framed air filter as installed in a receptacle of a powered air-handling apparatus, so that the anti-sag protrusions are correctly oriented (e.g. with their “shelves” or “barbs” facing in a generally vertically upward direction) to prevent the pleat tips of the air filter from sagging. In various embodiments, any of the above arrangements may be used.

In some embodiments, in framed filter 10, the upward pleat tips 205 of air filter 200 will not be adhesively bonded, or attached in any manner, to upward struts 141. Similarly, in some embodiments the downward pleat tips 206 of air filter 200 will not be adhesively bonded, or attached in any manner, to downward struts 41. Any such adhesive, e.g. in the form of a pressure-sensitive adhesive on the downstream face of upward struts 141, and/or on the upstream face of downward struts 41, might interfere with the ability to expand the pleated air filter 200 along these struts. Thus in some embodiments, no such pressure-sensitive adhesive will be present.

The exemplary illustrations herein depict downward struts 41, and upward struts 141, that are linear and are present in two sets of parallel struts, oriented so as to provide air-transmissive openings that are diamond-shaped. However, such struts can be of any suitable size, orientation, spacing, and so on, and do not necessarily have to be straight along their entire length. In various embodiments, such struts may be arranged in a square array, a hexagonal array, and so on. In some embodiments, downward struts 41 and upward struts 141 can be configured so that neither the upward face nor the downward face of a central area of pleated air filter 200 is covered by an upward strut or a downward strut. Such arrangements can provide that, for example, one or more sensors (e.g. a pressure sensor, a fine-particle sensor, etc.) can be positioned on or closely adjacent the air filter in the central area of the upward and/or the downward side of the air filter, so that the sensor(s) can function optimally e.g. without being affected by any slight disruption of airflow as might occur from the presence of a strut in that area.

In some embodiments, the above-described arrangements may be enhanced e.g. by setting the depth of receptacle 5 of the assembled frame 1, to be slightly less than the pleat height (denoted as P_{H} in FIG. 12) of the pleated air filter. This depth 6 (denoted in FIG. 7) of receptacle 5 will be defined by the distance between the downward face of the upward struts 141 of frame cover 120 and the upward face of the downward struts 41 of frame base 20. Setting the receptacle depth 6 relative to the pleat height P_{H} in this manner can provide that in the assembled frame, the pleated filter is held in slight compression; not enough to significantly deform the individual pleats or the pleated filter as a whole, but enough to ensure that the upward pleat tips very closely abut (e.g., are in contact with) the downward faces of upward struts 141 so that the upward pleat tips are unable to sag to any significant extent without contacting an anti-sag protrusion 142. Holding the pleated filter in slight compression in this manner can ensure that this remains the case in actual use of the framed filter; e.g., even with the pleated filter being slightly compressed in the downstream direction by the force of the air impinging on the upstream face of the pleated filter. Thus in various embodiments, the depth 6 of receptacle 5 of frame 1 may range from e.g. 100, 99, 98, or 97%, to 94, 95, or 96%, of the in-use pleat height P_{H} of pleated air filter 200.

Various other features and arrangements may be provided in frame base 20, in frame cover 120, and/or in frame 1 as a whole. For example, exemplary frame 1 as depicted in the Figures herein comprises rounded corners 4, which can make it easier to slidably insert a framed air filter 10 into a receptacle of a powered air-handling system. In some embodiments, such corners may comprise rounded bumpers 8 that further assist in this (however, if the frame base 20 comprises a downward sealing apron 70 as described earlier herein, the bumpers 8 will not extend outward past the outward edges 72 of apron 70). In some embodiments, each outward primary sidewall 31 of frame base 20 may have, somewhere along its length, a window 75 (whether e.g. in the form of a through-aperture or a through-aperture occupied by a transparent pane) through which an indicator zone 375 of an end pleat-panel of the air filter can be seen if the end pleat-panel is properly seated in the elongate slot 25 of the frame base. In some embodiments, each outward primary sidewall 131 of frame cover 120 may comprise a central panel 132 that comprises a through-aperture 133 that can allow an end-user to insert a finger thereinto e.g. in order to remove a framed air filter 10 from a receptacle of a powered air-handling system. (It is noted that each such “outward” sidewall 131 is the only primary sidewall of frame cover 120, the primary portions 122 of frame cover 120 being single-walled in contrast to the double-walled secondary portions 123 of frame cover 120 and the double-walled primary portions 22 and secondary portions 23 of frame base 20.) As evident from the Figures herein, various outward sidewalls of the frame base and/or the frame cover may be corrugated e.g. to increase the stiffness of the outer sidewalls and the stiffness of frame 1 as a whole. In some embodiments, the frame cover and frame base may be different colors so that they can be easily distinguished. In particular embodiments, the frame base may be relatively light in color (e.g. beige, light blue, light gray or tan) to make it easier to see into a slot 25 when installing a reinforced end pleat-panel of an air filter thereinto, with the frame cover being relatively dark in color (e.g. dark blue, brown or black). One or more outer sidewalls of the frame cover and/or the frame base may be provided with indicia to indicate a preferred installation orientation of framed air filter 10 (e.g. with the upward side of the framed air filter facing upstream). Such installation-orientation indicia may be e.g. embossed into the molded surface of a frame base or cover, may be printed on the frame case or cover, and/or may take the form of a label that is adhesively bonded to the frame base or cover.

A framed air filter 10 as disclosed herein can be inserted into a suitable receptable of a powered air-handling apparatus (or equivalently, system). The term powered air-handling apparatus encompasses, among others, room air purifiers and forced-air heating-ventilating-air-conditioning (HVAC) systems. In this context, the term HVAC broadly encompasses systems that perform only heating, systems that perform only cooling, and systems that perform both (of course, such systems can be operated to recirculate and filter air, even if the system is neither heating or cooling at the time). The framed air filter can be inserted and removed by any end-user; an end-user does not necessarily have to be an occupant (e.g. a homeowner or renter) of a dwelling. Rather, in many instances an end-user may be an HVAC service technician, a custodial or maintenance worker at a facility, and so on.

In many embodiments, a framed air filter 10 may be installed in a receptacle of a powered air-handling apparatus so that the “upward” side (U) of the framed air filter, per the terminology introduced earlier herein, is the “upstream” side of the framed air filter (that is, the side against which the moving airstream impinges). Likewise, the “downward” side (D) of the framed air filter will be the “downstream” side (through which the filtered air exits the filter). Discussions so far herein (e.g., discussions of an upward anti-sag lattice and a downward support lattice, discussions of upward/upstream pleat tips, and so on) have focused on arrangements of this type; such arrangements are referred to herein as a framed air filter being installed in an powered air-handling receptacle in a “standard” configuration. However, in some embodiments, a framed air filter can be installed in a receptacle in a “reverse” configuration; that is, with the “upstream” side of the installed framed air filter as installed, being the “downward” side of the framed air filter, and the “downstream” side of the installed framed air filter being the “upward” side of the framed air filter. The present investigations have revealed that in some embodiments, serviceable air filtration can be obtained when a framed air filter is installed in such a reverse configuration. In such a case, not all of the herein-described performance enhancements may necessarily be achieved in their entirety; however, such reverse installations are encompassed within the concepts disclosed herein. Thus for example, in some embodiments a framed air filter as disclosed herein may provide satisfactory air-filtration even if a user inadvertently installs the framed air filter in a reverse configuration. Indeed, in some embodiments a framed air filter may be designated (e.g., in signage and/or in user instructions) as reversible, so that the framed air filter may be installed in either standard or reverse orientation.

In further detail, if a framed air filter 10 is installed in a receptacle of a powered air-handling apparatus in a standard configuration, the pressure of the flowing air on the upstream face of the air filter will tend to keep the securing tabs 216 (e.g. reinforced end pleat-panels 211) of the air filter securely seated in the upward-open-ended elongate slots of the frame. If a framed air filter is installed in reverse configuration, the pressure of the air might, in theory, tend to urge the air filter in a downstream direction that could cause the securing tabs to at least partially exit the elongated slots (since, with the framed air filter installed in reverse configuration, the open ends 28 of the upward-open-ended elongate slots 25 will be facing downstream). However, the frame being of clamshell design, the air filter will be securely held within the frame, with no room for the securing tabs to completely exit the elongate slots. In fact, in many embodiments, the frame may not allow enough room for the securing tabs to partially exit the elongate slots to any significant extent. Configuring the frame and the air filter so that the air filter is held within the frame under slight compression in the manner discussed earlier herein, may enhance such arrangements. So, in many embodiments, a framed air filter that is installed in reverse configuration will not be susceptible to the air filter becoming wholly dislodged from the frame; furthermore, the securing tabs will not be able to become sufficiently dislodged from the frame to significantly adversely affect the air-filtration performance. Thus, while a standard installation is a presently preferred configuration, allowing as it does various enhancements to be exploited to their full advantage, a framed air filter that is installable in a reverse configuration is also encompassed within the concepts disclosed herein and may have advantages in certain aspects (e.g. flexibility of installation).

A receptacle for the framed air filter may be of any suitable type and design. In some instances, such a receptacle may be incorporated into ductwork that supplies return air to a heat-exchange unit (e.g. a furnace and/or air conditioner) of an HVAC system. Such a receptacle may be formed (e.g., on-site) by manipulating sheet-metal panels of a return-air duct or plenum to provide the receptacle. In some instances, a receptacle for a framed air filter may be incorporated in a return-air cabinet of a heat-exchange unit itself; such a receptacle will typically be formed at the factory when the heat-exchange unit is manufactured. In any event, any such receptacle will typically comprise a perimeter fixture, set of flanges, or the like, that have upstream-facing surfaces against which the downstream face of framed air filter 10 can be abutted. Such surfaces may be ideal for use with a frame whose frame base includes a downstream sealing apron 70 as described earlier herein.

At a desired time (e.g. if it is considered that the air filter is approaching the end of its useful life) the framed air filter 10 can be removed from the receptable of the powered air-handling apparatus (noting that the previously-described apertures 133 can facilitate this). The latch members 124 of the frame cover can be momentarily deflected outward to free them from the latch catches 24 of the frame base, and the frame cover can then be separated from the frame base. The securing tabs 216 of the spent air filter 200 can then be removed from the elongate slots of the frame base and the air filter removed from the frame base. A fresh air filter 200 can then be installed in the frame base and expanded to its in-use configuration. The frame cover can then be re-attached to the frame base and the resulting framed air filter can then be re-inserted into the receptacle of the powered air-handling apparatus.

In some embodiments, at least one air filter (e.g. pleatpack) 200 and/or a frame 1 may be provided as part of a kit, in any suitable format. For example, a starter kit may comprise a frame base and a frame cover along with at least one fully-collapsed pleatpack. In a convenient embodiment, in such a kit, the frame base and frame cover may already be mated to form the frame, with several fully-collapsed pleatpacks being packaged in the filter receptacle 5 of the frame (since the receptacle may be large enough to hold e.g. two, three, or even more fully-collapsed pleatpacks). An end user can separate the frame cover and frame base, remove the pleatpacks, and install one pleatpack into the frame in an expanded, in-use condition. Since frame 1 is reusable so that it can be used repeatedly over a long period of time, air filters 200 may be available in the form of replacement filter packs that include one, or multiple, collapsed pleatpacks, without any frame.

It will be apparent to those skilled in the art that the specific exemplary embodiments, elements, structures, features, details, arrangements, configurations, etc., that are disclosed herein can be modified and/or combined in numerous ways. In summary, numerous variations and combinations are contemplated as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). Although various theories and possible mechanisms may have been discussed herein, in no event should such discussions serve to limit the claimable subject matter. To the extent that there is any conflict or discrepancy between this specification as written and the disclosure in any document that is incorporated by reference herein but to which no priority is claimed, this specification as written will control.

What is claimed is:

1. A pleated air filter comprising a pleated layer of nonwoven electret filter media and a pleated stiffening layer attached to the layer of nonwoven electret filter media and co-pleated with the layer of nonwoven electret filter media, wherein the pleated air filter is expandable, along an expansion direction, from a first, compacted condition to a second, in-use condition, and wherein the pleated air filter comprises:
first and second opposing primary ends that are non-corrugated ends and that respectively comprise first and second securing tabs;
and,
first and second opposing secondary edges that are corrugated edges,
wherein the nonwoven electret filter media is compliant and wherein first and second opposing corrugated ends of the nonwoven electret filter media respectively extend outward beyond first and second opposing corrugated edges of the stiffening layer, in a direction at least generally aligned with a pleat direction of the pleated air filter and for a distance of 3 mm to 25 mm, so that first and second opposing corrugated edges of the nonwoven electret filter media provide the first and second opposing secondary corrugated edges of the pleated air filter and are self-sealing when abutted against inward secondary sidewalls of a filter frame in which the pleated air filter is installed.

2. The pleated air filter of claim 1 wherein a reinforcing sheet is mounted on an end pleat-panel of the pleated air filter to provide the first securing tab in the form of a reinforced end pleat-panel of the pleated air filter, the reinforcing sheet comprising an inward segment that is attached to an inward face of the end pleat-panel and an outward segment that is attached to an outward face of the end pleat-panel, the inward and outward sectors of the reinforcing sheet integrally meeting at a downward apex located downward of a downward tip of the end pleat-panel.

3. The pleated air filter of claim 2 wherein first and second opposing corrugated ends of the nonwoven electret filter media of the end pleat-panel of the pleated air filter respectively extend outwardly beyond first and second opposing outward edges of the inward and outward segments of the reinforcing sheet, in a direction at least generally aligned with a pleat direction of the pleated air filter and for a distance of from 1 mm to 25 mm.

4. The pleated air filter of claim 2 wherein the outward segment of the reinforcing sheet comprises an upward extension in a central area of the outward segment, the upward extension not being attached to an upward area of the end pleat-panel of the pleated air filter that the upward extension is adjacent to, and the upward extension comprising a through-aperture so that the upward extension can serve as a handle; and, wherein the inward segment of the reinforcing sheet comprises an upward notch in a central area of the inward segment, the upward notch of the inward segment being congruent with the upward extension of the outward segment.

5. The pleated air filter of claim 4 wherein the reinforcing sheet is a piece of chipboard that comprises a fold line that extends along the pleat direction of the pleated air filter and that is positioned so that the piece of chipboard is mounted on the end pleat-panel by being wrapped around the downward tip of the end pleat-panel and attached to the inward and outward faces of the end pleat-panel so that the fold line of the piece of chipboard is located downward of, and adjacent to, the downward tip of the end pleat-panel, and comprises the downward apex of the reinforcing sheet.

6. The pleated air filter of claim 5 wherein the pleated stiffening layer extends to the downward tip of the end pleat-panel of the pleated air filter and wherein the piece of chipboard is wrapped around the downward tip of the end pleat-panel so that a terminal end of the pleated stiffening layer is covered by the downward apex of the reinforcing sheet so that the terminal end of the pleated stiffening layer is not an exposed end.

7. The pleated air filter of claim 2 wherein the pleated air filter comprises at least two pleat-spacing-limiting elongate members that are located on an upward or downward side of the pleated air filter, that extend at least generally along the expansion direction of the pleated air filter and that are spaced apart along a pleat direction of the pleated air filter, and that are bonded to upward or downward pleat tips of the pleated air filter.

8. The pleated air filter of claim 7 wherein the pleat-spacing-limiting elongate members comprise:
two upward pleat-spacing-limiting straps that are on the upward side of the pleated air filter and that are bonded to the upward pleat tips of the pleated air filter, including an upward pleat tip of the end pleat-panel;
and,
two downward pleat-spacing-limiting straps that are on the downward side of the pleated air filter and that are bonded to the downward pleat tips of the pleated air filter, with the proviso that the downward pleat-spacing-limiting straps are not bonded to a downward tip of the end pleat-panel or to any part of the end pleat-panel.

9. The pleated air filter of claim 8 wherein the inward segment of the reinforcing sheet, that is attached to the inward face of the end pleat-panel, extends along the inward face of the end pleat-panel in a generally upward direction so that an upward edge of the inward segment of the reinforcing sheet is positioned within 1.5 cm of a location at which a pleat-spacing-limiting strap is bonded to the upward pleat tip of the end pleat-panel.

10. The pleated air filter of claim 1 wherein the pleated stiffening layer of the pleated air filter comprises a wire mesh that exhibits a percent open area of at least 95% and that is adhesively bonded to the downward surface of the pleated nonwoven electret filter media and that is co-pleated with the pleated nonwoven electret filter media.

11. The pleated air filter of claim 1 wherein the pleated air filter is a deep-pleat air filter that exhibits a pleat height, when in an in-use condition, of from 2 inches to 6 inches.

12. The pleated air filter of claim 1 wherein the pleated air filter comprises upward pleat tips and downward pleat tips, and wherein when the pleated air filter is in an in-use condition, the upward pleat tips and the downward pleat tips exhibit an average radius of curvature of from 1 mm to 4 mm.

13. The pleated air filter of claim 1 wherein the first and second opposing corrugated ends of the nonwoven electret filter media respectively extend outward beyond the first and second opposing corrugated edges of the stiffening layer, in a direction at least generally aligned with a pleat direction of the pleated air filter, for a distance of 3 mm to 10 mm

14. A method of installing the pleated air filter of claim 1 in a reusable frame, the method comprising:
inserting the first securing tab of the pleated air filter into a first upward-open-ended elongate slot of a first primary portion of a frame base;
expanding the pleated air filter along an expansion direction into an expanded, in-use condition;
inserting the second securing tab of the pleated air filter into a second upward-open-ended elongate slot of a second, opposing primary portion of the frame base, so that the pleated air filter is installed in the frame base;
then,
attaching a frame cover to the frame base to form a framed air filter comprising the reusable frame with the pleated air filter installed therein.

15. The method of claim 14 wherein first and second opposing secondary portions of the reusable frame comprise first and second opposing inward secondary sidewalls with first and second inward surfaces that extend along a secondary direction of the frame and that collectively define a width along a primary direction of the frame and along the pleat direction of the pleated air filter, of a filter-receptacle of the frame; and,
wherein the width of the filter-receptacle of the frame is from 1 to 7 mm less than a pleat-direction width of the nonwoven electret filter media of the pleated air filter, so that with the pleated air filter installed in the frame, the first and second opposing corrugated edges of the nonwoven electret filter media of the pleated air filter are respectively abutted against the first and second inward surfaces of the inward secondary sidewalls of the frame, so that at least some portions of the first and second opposing corrugated edges of the nonwoven electret filter media conform to the first and second inward surfaces of the inward secondary sidewalls of the frame so that the first and second opposing corrugated edges of the nonwoven electret filter media self-seal against the first and second inward surfaces of the inward secondary sidewalls of the frame.

16. The method of claim 14 wherein the first and second securing tabs of the pleated air filter each comprise an outward-facing indicator zone in a downward section of the securing tab, and wherein with the pleated air filter installed in the frame base, the indicator zone of the first securing tab is visible through a first window in a downward section of a first corrugated outward primary sidewall of a first primary portion of the frame base, and the indicator zone of the second securing tab is visible through a second window in a downward section of a second, opposing corrugated outward primary sidewall of a second, opposing primary portion of the frame base.

17. The method of claim 14 with the proviso that the first and second opposing corrugated edges of the nonwoven electret filter media are not bonded to the inward secondary sidewalls of the frame or to any portion of the frame; and, with the further proviso that neither the frame nor the pleated air filter comprises any resilient gasket or seal, other than the first and second opposing corrugated edges of the nonwoven electret filter media being compliant so as to self-seal when abutted against the first and second inward surfaces of the inward secondary sidewalls of the frame.

18. The method of claim 14 wherein the method is performed by an end-user and wherein the method includes a further step of installing the framed air filter into a receptacle of a powered air-handling apparatus chosen from the group consisting of an HVAC system and a room air purifier.

19. A kit comprising at least two of the pleated air filters of claim 1, wherein the at least two pleated air filters are each in the first, compacted condition.
